(19) United States
(12) Patent Application Publication
(10) Pub. No.: US 2010/0058114 A1
(43) Pub. Date: Mar. 4, 2010

(54) SYSTEMS AND METHODS FOR AUTOMATED MANAGEMENT OF COMPLIANCE OF A TARGET ASSET TO PREDETERMINED REQUIREMENTS

(75) Inventors: Richard A. Perkins, Belleville, IL (US); Larry Galvin, Swansea, IL (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: EADS NA Defense Security and Systems Solutions, Inc., San Antonio, TX (US)

(21) Appl. No.: 12/551,228

(22) Filed: Aug. 31, 2009

Related U.S. Application Data
(60) Provisional application No. 61/092,984, filed on Aug. 29, 2008.

(51) Int. Cl. G06F 11/07

(52) U.S. Cl. 714/39; 714/E11.024

(57) ABSTRACT

A system or method for automated management of compliance of a target asset to a predetermined requirement including receiving a predetermined requirement for compliance testing of one of a plurality of assets, comparing the received predetermined requirement to one or more stored compliance requirements to identify whether one or more stored compliance requirements corresponds to the received predetermined requirement, selecting a target asset from among the plurality of assets, transmitting the new compliance requirement, receiving results responsive to the transmitted new compliance requirement, and validating the received results to determine compliance of the target asset with the predetermined requirement as identified in the received results.

### CROSS-REFERENCE TO RELATED APPLICATIONS

This application claims the benefit of U.S. Provisional Application No. 61/092,984, filed on Aug. 29, 2008, the disclosure of which is incorporated herein by reference.

### FIELD

The present disclosure relates to systems and methods for certification and accreditation of an asset and, more specifically, to an automated System and method for certification and accreditation of an asset to predetermined requirements.

### BACKGROUND

The statements in this section merely provide background information related to the present disclosure and may not constitute prior art.

Current procurement requirements and mandates often require that computer systems receive Certification and Accreditation (C&A) at the time of activation and often on a periodic basis, such as once a year. This includes computer systems purchased and operated by corporate and government entities. For example, the federal government spends millions of dollars each year in order to complete C&A actions on its computer systems.

As one specific example, there are over 3,000 information systems (ISs) in the Air Force and in the Department of Defense (DOD) the number of computer systems are in the hundreds of thousands. Each such computer system requires a set of C&A tasks to be completed along with a Certification Test and Evaluation (CT&E), Security Test and Evaluation (ST&E), and the resulting reports (e.g., CT&E/ST&E Test Reports, Risk Assessments, Plan of Action and Milestones (POA & Ms), and Federal Information System Management Act (FISMA) reports). Based on the mandates outlined in the National Information Assurance Certification and Accreditation Process (NIACAP) and the DoD Information Assurance Certification and Accreditation Process (DIACAP), there is a huge demand for automation of such methods. The private sector has also followed suit in the C&A arena, and many corporate companies now require a C&A process for their systems.

While C&A services are provided to government and commercial organizations, existing such systems only provide manpower and expertise of the C&A process without offering an automated system that can assist in the process. Some companies offer an automated system, but such current systems, do not provide a true automated C&A System. Current systems and methods use repetitive processes that take extensive labor hours to complete a C&A. As such, the existing C&A processes are extremely time consuming and costly. The few automated C&A systems that currently exist do not cover all the phases of C&A activities. As such, the inventors hereof have identified the significant need to streamline and automate as much of the C&A process as possible.

### SUMMARY

The inventors hereof has succeeded at designing automated systems and methods for management of the assessment of an asset to predetermined requirements, such as a computer system for certification and accreditation to predetermined requirements. One exemplary of is described here which is referred herein generically as an Automated C&A (AC&A) System and in one embodiment as an advance risk management of enterprise security System (ARMOES) (hereinafter referred generically as the AC&A System). Additionally, this includes associated methods established and described herein, provides for all of the appropriate test plans, phases, and other documentation of C&A efforts for these target computer systems. The capabilities of the systems and methods herein can significantly reduce the time needed to analyze and document various C&A processes. The systems and methods of this disclosure provide functionality and capability in an automated manner to cover all C&A activities that a company needs. This automated System will reduce the cost of completing C&A actions for the various system program offices by reducing the labor and travel cost needed to perform a C&A.

According to one aspect, a system or method for automated management of compliance of a target asset to a predetermined requirement including receiving a predetermined requirement for compliance testing of one of a plurality of assets, comparing the received predetermined requirement to one or more stored compliance requirements to identify whether one or more stored compliance requirements corresponds to the received predetermined requirement, selecting a target asset from among the plurality of assets, transmitting the new compliance requirement, receiving results responsive to the transmitted new compliance requirement, and validating the received results to determine compliance of the target asset with the predetermined requirement as identified in the received results.

According to another aspect, a method, system or computer readable medium having instructions for automated management of compliance of a target asset to a predetermined requirement including receiving a predetermined requirement for compliance testing of one of a plurality of assets, and comparing the received predetermined requirement to one or more stored compliance requirements to identify whether one or more stored compliance requirements corresponds to the received predetermined requirement. Where one or more of the stored compliance requirement corresponds to the received predetermined requirement, the method includes modifying at least one corresponding compliance requirement responsive to the received predetermined requirement to generate a new compliance requirement. Where the received requirement does not correspond to at least one stored compliance requirements, the method includes generating a new compliance requirement responsive to the received predetermined requirement. The method also includes selecting a target asset from among the plurality of assets, transmitting the new compliance requirement, and receiving results responsive to the transmitted new compliance requirement. The method further includes validating the received results to determine compliance of the target asset with the predetermined requirement as identified in the received results and publishing a compliance report including the received results responsive to the validating.

According to yet another aspect, a method for automated management of compliance of a target asset to a predetermined requirement can include receiving a selection of the target asset from among a plurality of assets, establishing a profile for the selected target asset, and validating the profile of the target asset against at least one of the new or modified corresponding compliance requirement sets and transmitting the generated corresponding compliance requirement set to an external system or an output device. The method can also include receiving results data from the external system or an input device responsive to the transmitting. This received results data can include a correlation to one or more compliance requirements within the transmitted compliance requirement set. The method can also include validating the received results data to determine compliance with at least one of the new or modified corresponding compliance requirement set. A compliance report can be published responsive to the validating.

According to still another aspect, a method for automated management of compliance of a target asset to a predetermined requirement can include receiving a predetermined requirement for compliance testing of the target asset, comparing the received predetermined requirement to one or more stored compliance requirement sets to identify whether one or more of the stored compliance requirement sets corresponds to the received predetermined requirement. Where the comparing identifies one or more stored compliance requirement sets that correspond to the received predetermined requirement, the method includes modifying at least one of the corresponding compliance requirement sets responsive to the received predetermined requirement to generate a new compliance requirement set. Wherein the comparing fails to identify at least one stored compliance requirement set, the method includes generating a new compliance requirement set responsive to the received predetermined requirement. The method can also include comparing the received predetermined requirement to one or more stored compliance requirements to identify whether one or more stored compliance requirements corresponds to the received predetermined requirement. As before, where one or more of the stored compliance requirement corresponds to the received predetermined requirement, the method can providing for modifying at least one corresponding compliance requirement responsive to the received predetermined requirement to generate a new compliance requirement. However, where the received requirement does not correspond to at least one stored compliance requirements, the method provides for generating a new compliance requirement responsive to the received

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a block diagram of an automated compliance and accreditation system as implemented in one exemplary embodiment.

FIG. 2 is an entity-relationship diagram for one embodiment of an automated compliance and accreditation system.

FIG. 3 is a high level block diagram of a logical data model for an automated compliance and accreditation system according to one exemplary embodiment.

FIG. 4 is an expanded portion of the logical data model of FIG. 3 showing details related to the user functionality according to one exemplary embodiment.

FIG. 5 is an expanded portion of the logical data model of FIG. 3 showing details related to the target asset/system functionality according to one exemplary embodiment.

FIG. 6 is an expanded portion of the logical data model of FIG. 3 showing details related to information assurance (IA) Controls functionality according to one exemplary embodiment.

FIG. 7 is an expanded portion of the logical data model of FIG. 3 showing details related to test case and test plan functionality according to one exemplary embodiment.

FIG. 8 is an expanded portion of the logical data model of FIG. 3 showing details related to results, test event and reporting functionality according to one exemplary embodiment.

FIG. 9 is an expanded portion of the logical data model of FIGS. 3, 7, and 8 showing details related to the interworkings and interactions between the test cases and test plans and the associated results, test events, and reporting according to one exemplary embodiment.

FIG. 10 is a flow diagram of a new source document process in an automated compliance and accreditation system according to one exemplary embodiment.

FIG. 11 is a flow diagram of a new system entry process in an automated compliance and accreditation system according to one exemplary embodiment.

FIG. 12 is a flow diagram of a new source document process in an automated compliance and accreditation system according to one exemplary embodiment.

FIG. 13 is a flow diagram of a new results process in an automated compliance and accreditation system according to one exemplary embodiment.

FIG. 14 is a flow diagram of a reporting process in an automated compliance and accreditation system according to one exemplary embodiment.

FIG. 15 is a block diagram of a computer System that can be used to implement a method and apparatus embodying the systems and methods of the present disclosure according to one exemplary embodiment.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses. Before turning to the figures and the various exemplary embodiments illustrated therein, a detailed overview of various embodiments and aspects is provided for purposes of breadth of scope, context, clarity, and completeness.

In one embodiment a method, system or computer readable medium having instructions for automated management of compliance of a target asset to a predetermined requirement including receiving a predetermined requirement, such as from a source document, for compliance testing of one of a plurality of assets. Each asset can have a profile including a category and classification for the asset. The method also includes comparing the received predetermined requirement to one or more stored compliance requirements to identify whether one or more stored compliance requirements corresponds to the received predetermined requirement.

Where one or more of the stored compliance requirement corresponds to the received predetermined requirement, the method includes modifying at least one corresponding compliance requirement responsive to the received predetermined requirement to generate a new compliance requirement. Where the received requirement does not correspond to at least one stored compliance requirements, the method includes generating a new compliance requirement responsive to the received predetermined requirement. The method also includes selecting a target asset from among the plurality of assets, transmitting the new compliance requirement, and receiving results responsive to the transmitted new compliance requirement. The method further includes validating the received results to determine compliance of the target asset with the predetermined requirement as identified in the received results and publishing a compliance report including the received results responsive to the validating.

The method can also include identifying a new asset, creating a new profile for the new asset including a classification and a category associated with the new asset, identifying one or more stored compliance requirements associated with the classification and category within the created profile of the new asset and automatically adding the identified one or more stored compliance requirements to the new profile for the new asset.

It should be noted that each asset can be a system having a plurality of machines and the compliance requirement is a system level compliance requirement, and wherein transmitting the new compliance requirement includes transmitting associated with each of the machines of the target asset and receiving results is for each of the machines.

The method can also include identifying any failures from the received results, creating a program management responsive to the failures, the program management including mitigation responses to the failures, and wherein publishing further includes publishing a program management report.

In another embodiment, an implemented method can include receiving a predetermined requirement for compliance testing of the target asset, comparing the received predetermined requirement to one or more stored compliance requirement sets to identify whether one or more of the stored compliance requirement sets corresponds to the received predetermined requirement. Where the comparing identifies one or more stored compliance requirement sets that correspond to the received predetermined requirement, the method includes modifying at least one of the corresponding compliance requirement sets responsive to the received predetermined requirement to generate a new compliance requirement set.

Wherein the comparing fails to identify at least one stored compliance requirement set, the method includes generating a new compliance requirement set responsive to the received predetermined requirement. The method can also include comparing the received predetermined requirement to one or more stored compliance requirements to identify whether one or more stored compliance requirements corresponds to the received predetermined requirement. As before, where one or more of the stored compliance requirement corresponds to the received predetermined requirement, the method can providing for modifying at least one corresponding compliance requirement responsive to the received predetermined requirement to generate a new compliance requirement. However, where the received requirement does not correspond to at least one stored compliance requirements, the method provides for generating a new compliance requirement responsive to the received predetermined requirement.

In some embodiments, the method can provide for comparing the received predetermined requirement to a stored compliance requirement includes reviewing the received predetermined requirement and identifying deficiencies in at least one of the stored compliance requirements. The method can also provide for reviewing support documentation responsive to the identified deficiencies and preparing solutions to address the identified deficiencies in support of the predetermined requirement. The modification to the compliance requirement can include at least one corresponding compliance requirement includes the prepared solutions.

In another embodiment, a method can include receiving a selection of the target asset from among a plurality of assets, establishing a profile for the selected target asset, and validating the profile of the target asset against at least one of the new or modified corresponding compliance requirement sets and transmitting the generated corresponding compliance requirement set to an external system or an output device. The method can also include receiving results data from the external system or an input device responsive to the transmitting. This received results data can include a correlation to one or more compliance requirements within the transmitted compliance requirement set. The method can also include validating the received results data to determine compliance with at least one of the new or modified corresponding compliance requirement set. A compliance report can be published responsive to the validating.

It should be understood to those skilled in the art that the predetermined requirements can be first predetermined requirements, and that one or more second predetermined requirements can also be provided such that any of the second predetermined requirements replaces in whole or in part the first predetermined requirements.

In another embodiment, a method of managing a compliance of a target asset to a one or more predetermined requirements. The target asset can be any asset for which compliance is desired. This can include, but is not limited to computer systems, manufacturing systems and processes, business processes and systems, educational processes and systems, financial processes and systems, communication processes and systems, by ways of examples. The predetermined requirements selected from the group of parameters consisting of policies, procedures, guidelines, laws, regulations, by way of examples.

By way of example only, this disclosure utilizes an exemplary target asset of a computer system for which compliance to a predetermined requirement, such as the Department of Defense Instructions/Directives for computer security (one or more of DODI 8510, DODI 8500.2, and DODD 8500.1). However, it should be understood that such target asset and such predetermined requirement is only by way of example, and should not be considered limiting.

The AC&A methods can include methods of receiving a compliance requirement for a test plan, comparing the received test plan with the stored test plans to identify the pre-existence of the received test plan within the stored test plans and comparing the received compliance requirement to a stored compliance requirement within the stored test plan. The method also includes modifying the stored test plan responsive to the received compliance requirements and generating a target asset test plan from the modified test plan when the received compliance requirement is the same as one of the stored test plans or generating a target asset test plan responsive to the received compliance requirement when the received compliance requirement is different than a stored test plan.

In one embodiment the method of comparing the received compliance requirement to a stored compliance requirement can include reviewing the received compliance requirement, identifying deficiencies in the compliance requirement, reviewing support documentation responsive to the identified deficiencies, and preparing solutions to address the identified deficiencies in support of the compliance requirement.

Additionally, the method can include one or more of: performing a quality assurance check of the target asset test plan responsive to the new compliance requirements, or flagging the target asset test plan as being updated following successfully performing the quality assurance check.

In another embodiment, a method of managing a compliance of a target asset to a predetermined requirement includes selecting the target asset from among a plurality of assets, establishing a baseline profile for the target asset and validating the baseline profile of the target asset against a set of validation parameters, retrieving stored predetermined requirements. The method also includes reviewing stored test plans including comparing the test plans against the retrieved predetermined requirements and responsive to the selected target asset and selecting all or a portion of one or more of the stored test plans responsive to the reviewing including the comparing. The method further includes generating a target asset test plan including all or a portion of the selected test plans, transmitting the generated target asset test plan to an external system or an output device and receiving one or more results data from the external system or an input device. The received results data includes a correlation to one or more test cases within the generated and transmitted target asset test plan. The method also includes validating the received results data to ensure compliance with the target asset test plan and the predetermined requirements and publishing a compliance report responsive to the predetermined requirements and the validated received results. This can include formatting all or a portion of the results data and the predetermined requirements into a format defined by the predetermined requirements.

In some embodiments, the method can include creating a profile for a target asset among the plurality of assets and storing the created target asset profile. In some embodiments, at least one of the stored test plans can include a plurality of test cases and selecting all or a portion of a stored test plan includes selecting a subset of the plurality of the test cases within one or more of the stored test plans. The method process of generating the target asset test plan can include generating test questions adapted to evaluate and/or quantify one or more processes or methods of the generated test plan.

Additionally, the method of the AC&A systems can include generating one or more instructions for initiating at least one remote test case included in the target asset test plan, logging results data associated with the generated instruction remote test case, importing the results data following logging, and assigning the imported results data to at least one of the target computer test plans, the target computer profile, and at least one of the remote test cases.

Of course it should be understood to those skilled in the art that the predetermined requirements can be first predetermined requirements and additional predetermined requirements such as second predetermined requirements can also be imported. In such embodiments, the second predetermined requirements can replace in whole or in part the first predetermined requirements.

In another embodiment, a system for automated management of compliance of a target asset to a predetermined requirement includes receiving a predetermined requirement for compliance testing of a target asset and comparing the received predetermined requirement to stored test plans to identify the existence of a corresponding test plan. The method also includes comparing the received predetermined requirement to a stored compliance requirement within the stored test plans and modifying the stored test plan responsive to the received new compliance requirements and generating a target asset test plan from the modified test plan when the received compliance requirement is the same as one of the stored test plans or generating a target asset test plan responsive to the received predetermined requirement when the received predetermined requirement is different than a stored test plan. The method further includes selecting the target asset from among a plurality of assets, establishing a baseline profile for the target asset and validating the baseline profile of the target asset against a validation parameter. The method also includes transmitting the generated target asset test plan to an external system or an output device and receiving one or more results data from the external system or an input device, the received results data including a correlation to one or more test cases within the generated and transmitted test plan. The method includes validating the received results data to ensure compliance with the target asset test plan and the predetermined requirements and publishing a compliance report responsive to the predetermined requirements and the validated received results.

As another exemplary embodiment of a system and method of this disclosure, an automated certification and accreditation System (AC&A System) as described herein can utilize and/or take the form of a computer system or application and in some embodiments can be embodied as a database application for maintaining, administering and managing the appropriate test plans and other documents needed to provide the C&A efforts for a target computer system. The capabilities of the AC&A systems and methods can provide for significantly reducing the time needed to analyze and document various test events. This system and the methods have been created to store, manage, and create test plans, reports, addendums, by ways of examples, for use in C&A effort on target assets such as computer systems. The AC&A system provides an automated approach for completing portions of the C&A process on various target asset computer systems.

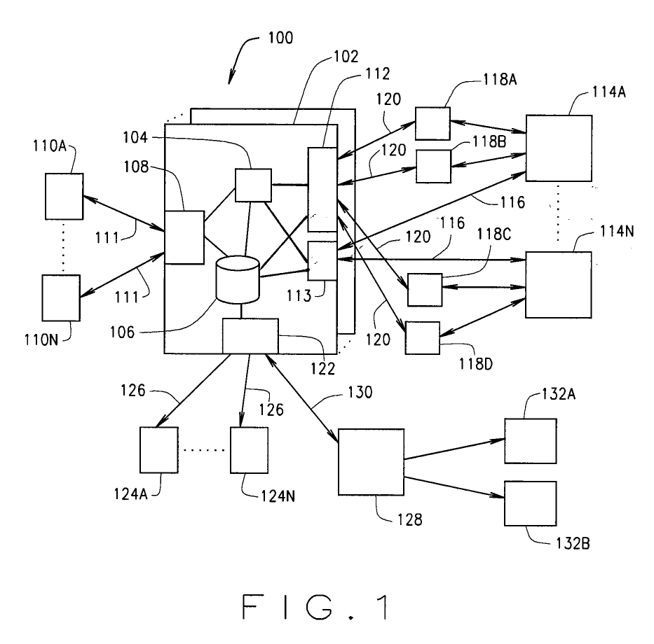

FIG. 1 illustrates an exemplary block diagram of an AC&A System 100. As shown, the AC&A System 100 can host a user interface 108 such as a GUI for hosting a plurality of users Uₙ. The AC&A System 100 can include one or more computer processing components or Systems and include one or more processing units, memory, database applications, input/outputs, communication links to various networks, and a plurality of other operating systems for performing the methods as described herein. Tester users 202 can receive test plans 224 (also referred herein to as a compliance requirement set) or test cases 222 (also referred to as a compliance requirement) directly or indirectly for the AC&A system. The tester users 202 can be remote systems or can be persons or their computer or other support system. The tester users 202 perform compliance test cases 222 on the target assets TAN and return the test results 220 back to the AC&A System 100. Additionally, automatic test links can be utilized wherein the AC&A System 100 can directly communicate with and/or access the target assets for performing one or more test cases 222 and receiving back the test results. An external reporting sub-system provides the necessary compiled reports, data and compliance information to external Reporting Entities that can include persons, communication links, or systems.

In one embodiment, by way of example, an AC&A System 100 for example, the systems and methods herein can aid in the compliance with the recently mandated NIACAP and DIACAP processes of the Federal government for required tests, reports, evaluations and other actions that are to be performed in order to gain authorization for a target computer or asset to connect to the network. The systems and methods provided by this disclosure provides for the management of the mandated Defense Information Systems Agency (DISA) Security and Technical Implementation Guide (STIG) and provides for the importing/exporting of test data into formats and reports as required by various entities such as Designated Approving Authority (DAA), Certification Authority (CA), and User Representative (UserRep, and Program Manager (PM)). They can also enable the management of all the Information Assurance (IA) controls as well as the results of the validation activities including all the findings associated with a particular target computer system. Finally, the systems and methods described herein enable a user to maintain situational awareness by providing easy access to current and historical data on all tested target computer systems.

The AC&A System 100 provides for the creation of information needed for FISMA reporting and the exporting of reports (such as spreadsheet files or otherwise) that outline the information needed to build a plan of action and milestone (POA&M). The systems also can generate the scorecard needed for the DAA to make a determination for target asset accreditation. The AC&A System 100 can be implemented, in one embodiment, as a fully automated system that is web enabled so that fewer personnel have to travel to test sites to complete the DIACAP actions for a given target computer system. This can be accomplished as a porting of the existing certification and accreditation system and forms into a web-based application and can include code that is modular and embedded into an overarching framework for adding new features, as well as providing a uniform and consistent approach to internal design. It can also evaluate the data sets to provide normalization to the certification and accreditation system and thus reduce overhead from a system administrator perspective.

In some embodiments, the target computer asset or system can be the actual computer System itself for AC&A testing. In other embodiments, however, a network or computer system or asset can be, in whole or in part, simulated for AC&A testing. In these later embodiments, the AC&A testing can be performed in a complete lab environment. For example, a simulator or simulation of a target asset can be used to model a target asset without having to directly test the target asset itself. In this manner, a user can set up a given target computer system (i.e., TBMCS, GCCS, by ways of examples) in the lab and test it using the automated AC&A System 100 such that the live system does not have to be affected or accessed. In this case, the system test plans are built in a lab to test their target computer systems. This can reduce the cost of the C&A testing considerably as very few personnel would have to travel to a remote site of the target computer system or asset to complete the testing and mitigations. These actions alone would save significant cost for the System Program Management Office (PMO) or Officers.

In various embodiments, the AC&A System 100 can provide one or more of: CT&E/ST&E/POA&M client/server module capabilities; web browser client front-end capabilities; an Information Assurance Assessment and Assistance Program (IAAP) module; a full DIACAP Package Processor (System Security Authorization Agreement (SSAA) Documents with Scorecard and FISMA Reporting module); a full NIACAP Package Processor (SSAA Documents with FISMA Reporting module); a full Director of Central Intelligence Directive (DCID) 6/3 Package Processor (SSAA Documents with FISMA Reporting module); and an enterprise Information Technology Data Repository (EITDR), Defense Information Technology Portfolio Repository (DITPR), Enterprise Mission Assurance Support Service (eMASS), and Vulnerability Management System (VMS) interoperable front-end clients.

In other embodiments, the AC&A System 100 can also address a known Level of Effort (LOE) to update its library of mandated requirements (i.e., DIACAP mandates, corporate mandates for a company, by way of examples). The LOE varies and can be dependent on the magnitude of the updates required (i.e., simple update to large new STIG). Historical LOE data shows that updates range from a few hours to 40 hours, but the mean update time is approximately 16 hours.

The AC&A System 100 can provide for testing and validating the security of two or more target computer systems. This can involve testing of applications/OS installed on each of a plurality of target computer systems, based on requirements spelled out in the associated Security Technical Implementation Guides (STIG) and Checklist. Test plans can be developed for each of these applications/OSs using the appropriate STIG and Checklist and used during the audit. On occasion, customized test plans can be utilized, such as for validating that corrections have been made to the system as directed in a previous test cycle.

### Exemplary Data Design

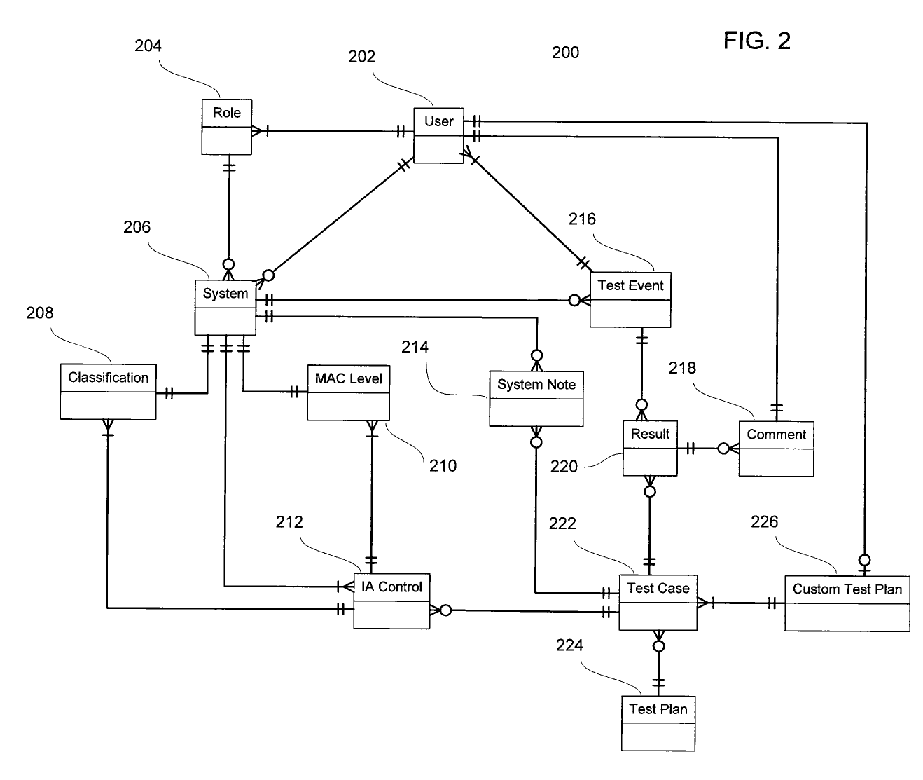

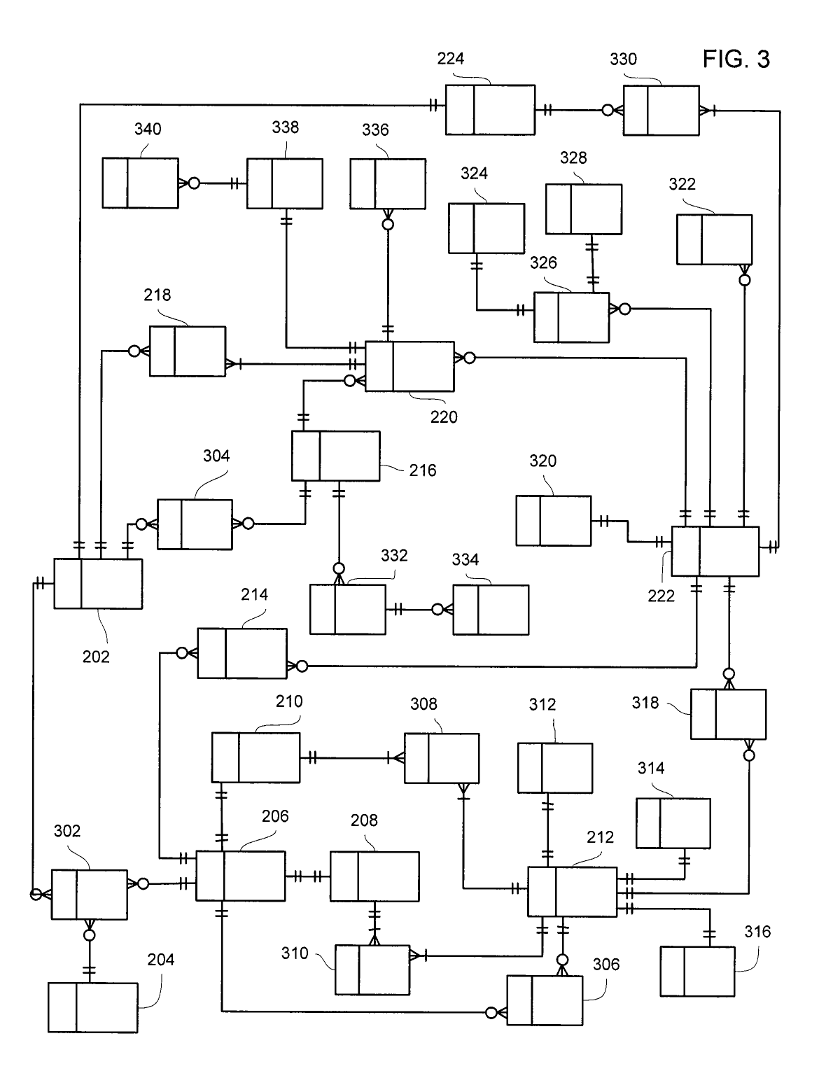

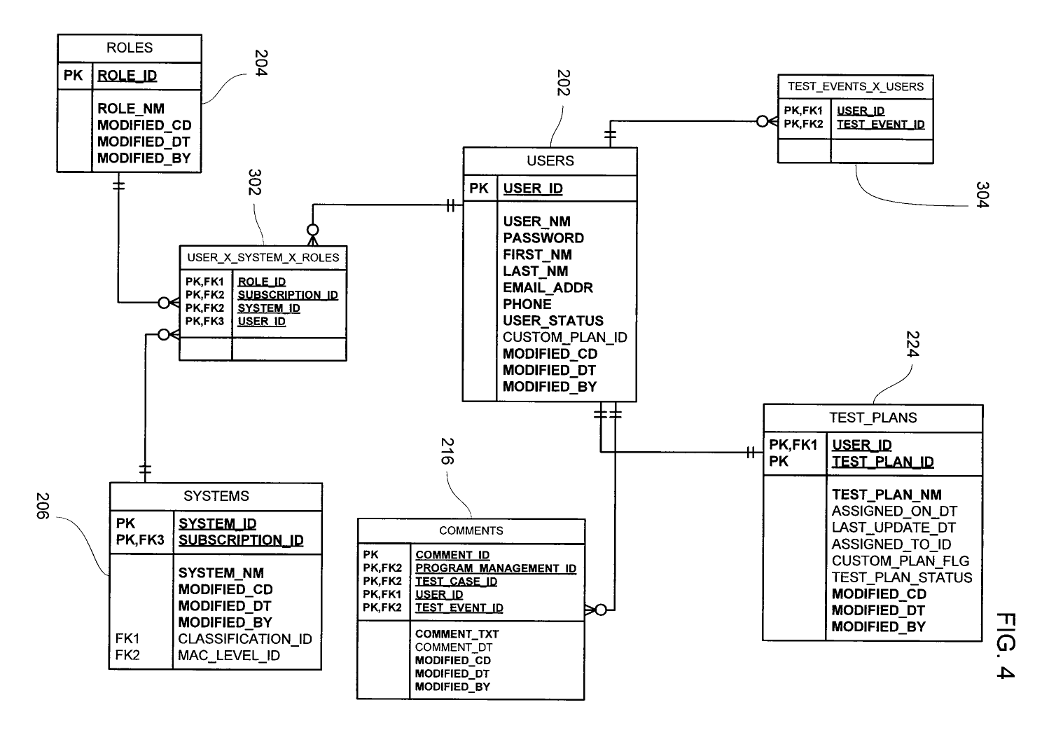

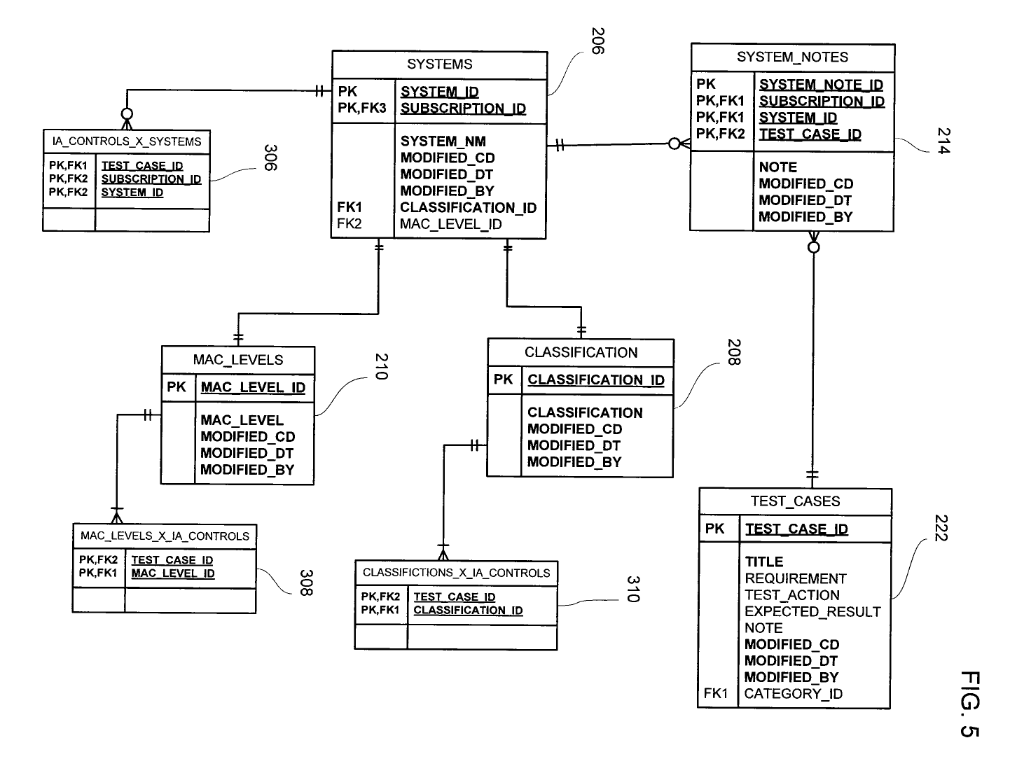

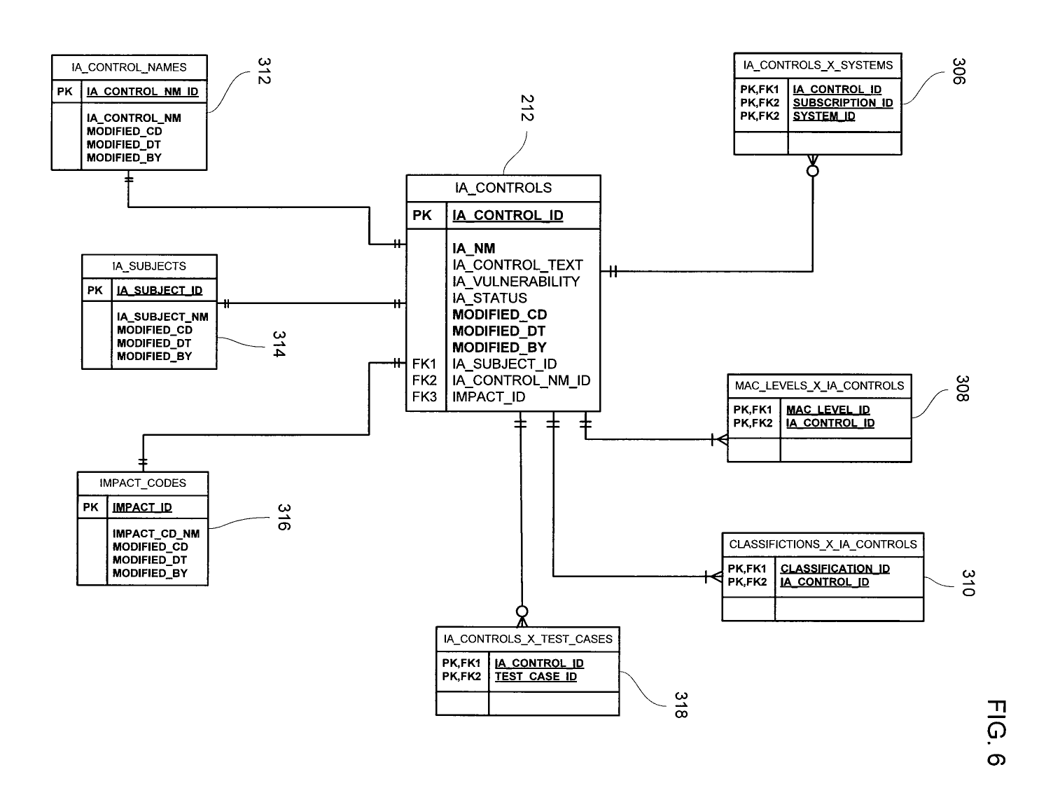

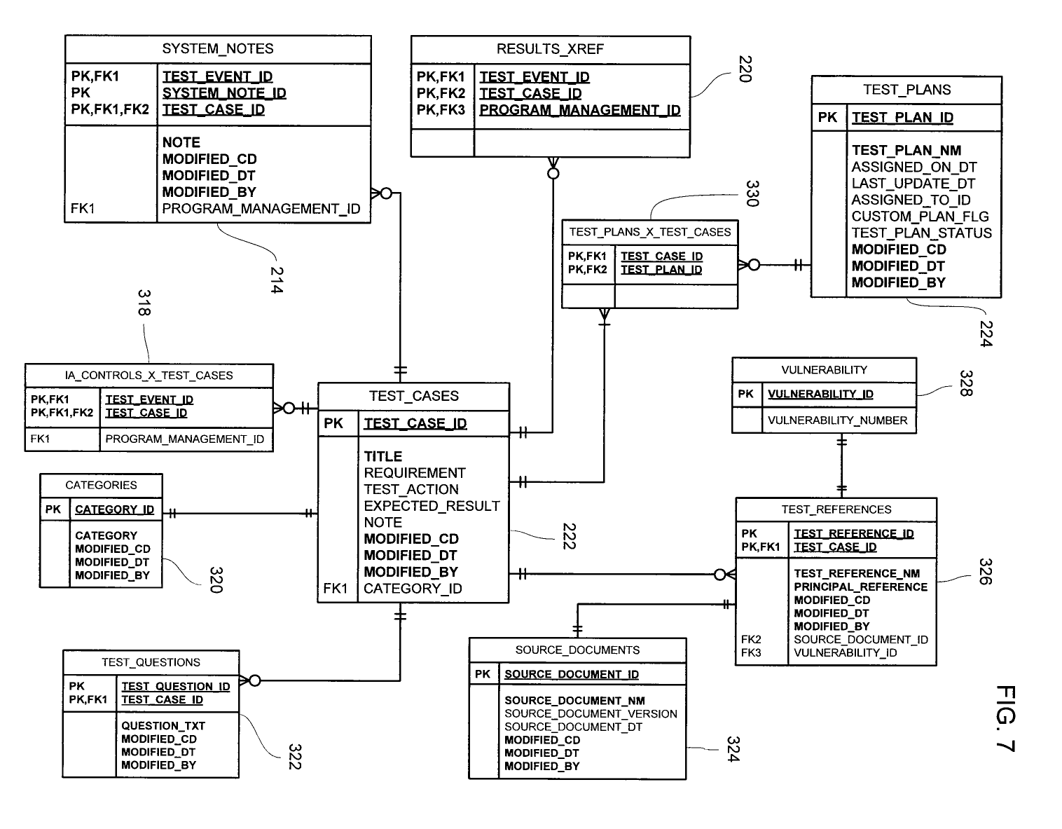

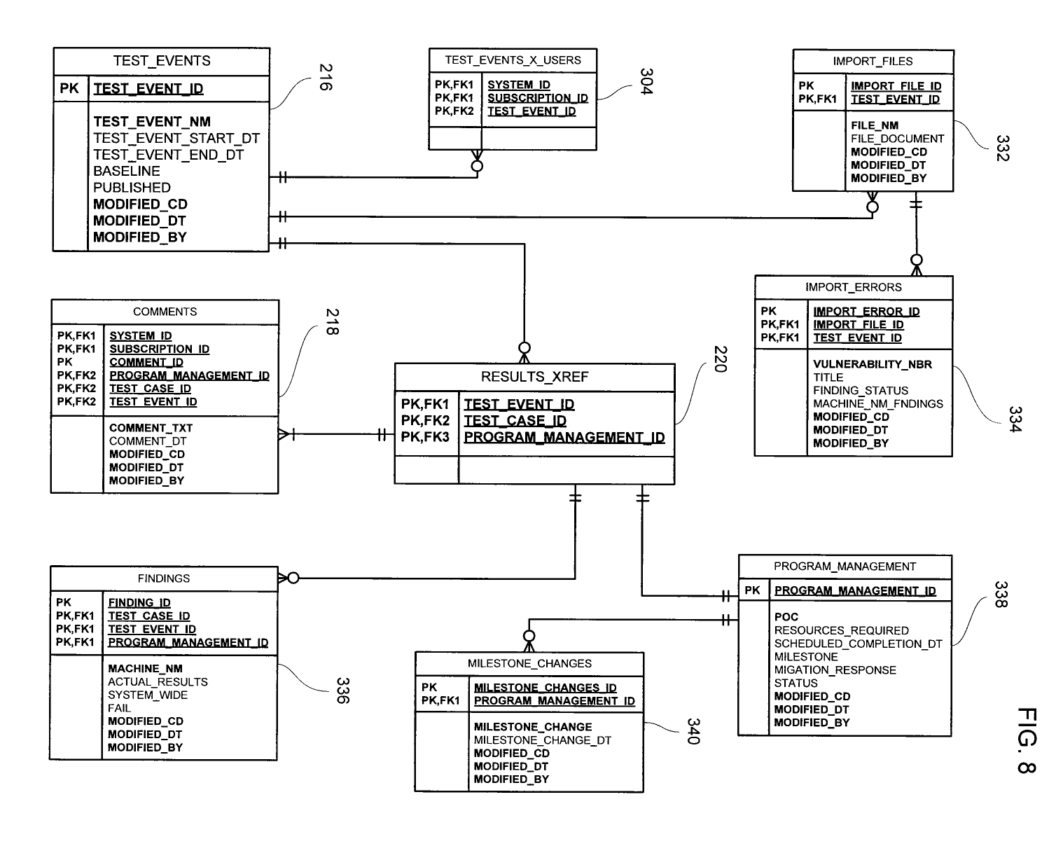

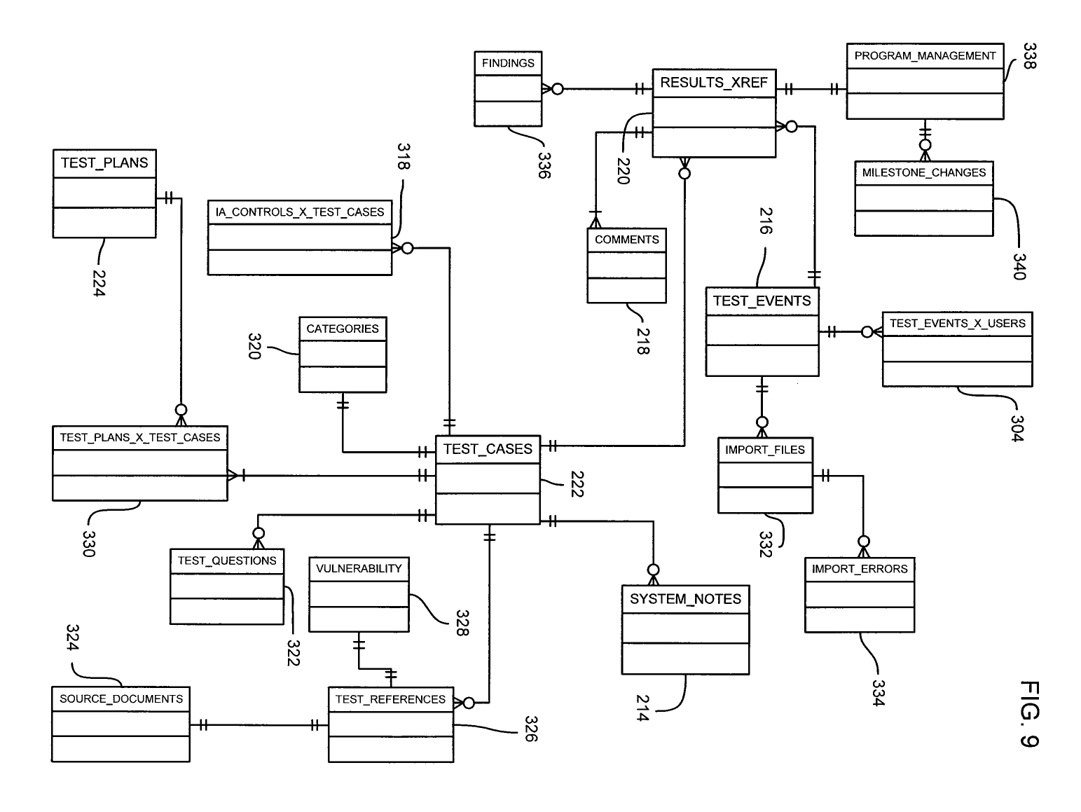

An AC&A System 100 can be designed using a normalized, entity-relationship, and logical configuration to insure optimal data processing and retrieval. On embodiment of an entity-relationship diagram (ERD) 200 as known to those skilled in the art of database design and management is illustrated in FIG. 2 and will be referred to below with regard to the definitions and relationships between the various illustrated entities. Similarly, FIG. 3 illustrates one embodiment of a logical data model 300 at a high level that is one embodiment of relationships between various AC&A System 100 entities. FIGS. 4-9 provide subportion details of FIG. 3 to include exemplary data elements and characteristics within the entities and that correspond to the following exemplary data design and explanation thereof. The below explanations of the entities provides detailed information including parameters, data types, and indexes, and includes the relationship to each System application or module, i.e., Test Case Editor, Administration Setting, IA Control Manager, Test Event Manager, System Manager, User Manager, Findings, Reports, Source Document Manager, and Test Plan Manager, by way of examples. The AC&A System 100 can use an indexed database access method as known to those skilled in the art and or otherwise suitable for the particular implementation hereof.

As such, referring to FIGS. 2-9, the following are entities and attributes (i.e., fields and/or data elements) as referenced herein with regard to one exemplary embodiment of the AC&A System 100. These are only exemplary in nature and are not intended to be limiting and the disclosure is not limited to these particular entities and attributes, their design or collection or relationship, as one skilled in the art would understand that others and variations are also within the scope of the present disclosure. This includes entities and attributes being added, details of attributes (e.g. lengths, usages, keys) being added and modified, and attributes moved between entities in other embodiments.

The AC&A System 100 can include a user interface that can be copied to the local computer and run to access the AC&A System 100. These can include those identified in FIG. 1 as interfaces 108, 112, 113, and 122. In some embodiments, a different or separate database can be utilized for the test plans 224 and can be maintained on the unclassified network. In yet other embodiments, a separate database can be utilized for actual findings, the test events, and the target asset/computer system 206 notes.

When the user interface of the AC&A System 100 is executed, the main menu can be displayed, providing access to the available functionality. The AC&A System 100 version can be shown on the user interface. Buttons such as icons can be provided to link the user 202 to the desired functionality. For example, a door icon can be used to exit the program. Current contract information and restrictions on the data can be provided on the screen as well.

1) IA Controls

An Information Assurance (IA) Control 212 defines a predetermined requirement, such as, for example, a security requirement, or a computer system based on a particular standard or compliance source document. Each IA control 212 has a unique name, e.g., IA control name 213. Some examples of names of IA controls 212 include, but are not limited to, the following names: Acquisition Standards. Audit Record Content—Sensitive Systems, Best Security Practices, Compliance Testing, Conformance Monitoring and Testing, Data Backup Procedures, Data Change Controls, Disaster and Recovery Planning, Encryption for Need-To-Know, Group Authentication, Identification of Essential Functions, Key Management, Remote Access for Privileged Functions, Security Rules of Behavior or Acceptable Use Policy, System Library Management Controls, Token and Certificate Standards, Virus Protection, and Workplace Security Procedures.

Each IA control 212 also includes a Control Text that defines the requirements of the IA control 212. The IA Control Subjects 314 can include Continuity, Enclave Boundary Defense, Enclave Computing Environment, Identification and Authentication, Personnel, Physical and Environmental, Security Design and Configuration, and Vulnerability and Incident Management.

The IA control 212 includes a vulnerability 328 for the IA control 212 that defines the threat, vulnerability, or countermeasure therewith associated with it, and a status or state of the IA control 212. Each IA control 212 typically has a subject, an impact code that represents a value of the impact of the IA control 212 on a system 206 such as high, medium and low, one or more Mission Assurance Category (MAC) Levels 210 that represents the values for the MAC levels 210 of an IA control 212 or system 206, and a classification 208 such as Classified, Sensitive, Public, and Custom, by way of examples.

Each IA control 212 defines a predetermined requirement that may be an existing requirement or a new requirement. The IA control 212 is created by the IA Control Manager and is utilized by the IA Control Manager, the System Manager, the Test Case Editor, the findings 336, and the Reports.

The IA controls 212 can include text or data that defines the requirements of the control item that can be a predetermined requirement or a new requirement. The IA control 212 can also include an indication of the vulnerability 328 that defines the threat or vulnerability and/or countermeasure. Additionally, a status of the IA control 212 can also be included.

2) Requirements

A requirement identifies a description of the test requirement necessary to comply with or pass the IA control 212. The requirements can contain fields such as a textbox, and a cross reference to an IA controls 212. However, it should be understood with the scope of the present disclosure that requirements is defined broadly. Requirements can be pre-existing or predetermined within the AC&A System 100 or source documents 324 or can be new or changed as defined from time to time from new source documents 324 or other sources, including input from a user 202.

3) Test Info

A test info parameter/field contains information related to the test for the requirement such as one or more test actions described by text, and can include an expected result from a test for the requirement.

4) Control Administration

A Control Administration provides for management of IA controls 212 including viewing, adding, editing and deleting of IA controls 212.

5) Assets/Systems

An asset is a target of the compliance testing of the AC&A system 206 and can include systems 206 or devices such as computer systems for which tests for compliance with one or more IA controls 212 is desired. Generally, herein the asset is referred by way of example as a System. Each such system 206 can be defined by a Profile and is managed and utilized by the System Manager. Each system 206 has a unique System Name and Identification ID, and can be assigned a classification 208, and MAC level 210, as well as other characteristics and parameters as may be desired for the particular application.

Each asset or target asset is provided a system name that uniquely identifies the target asset. Additionally a profile for each system 206 can include additional characteristics or parameters including a MAC level 210, a classification 208, and one or more IA controls 212. Additionally, the asset profile can also include one or more test events 216 from previously preformed tests. As will be discussed, a system 206 can have one or more associated machines, e.g., multiple machines may be within a single system 206.

A Systems Administration application can provide for management of systems 206 including the selection of existing systems 206 within the AC&A System 100, creation of new systems 206 and added in or renaming of new systems 206. Upon selection of a system 206, the IA controls 212 and test events 216 associated with the selected system 206 can be viewed by a user. When a new system 206 is added, all IA controls 212 that match the System's MAC level 210 and classification 208 can be automatically added to the system 206 such as the profile for that system 206. However, in some embodiment, this does not include automatically adding of IA controls 212 with a classification 208 of Custom, as Custom classifications can be specific to particular systems 206. Test events 216 can be added or deleted. This can include the test event name, start date; end date, users, and a baseline state.

6) IA Controls Cross Reference to Systems

The IA Controls Cross Reference to Systems 306 defines a cross reference relationship between an IA control 212 and a system 206. The cross reference 306 is created by the System Manager in conjunction with the establishment of a Profile for the system 206 and is used by the System Manager.

7) IA Controls Cross Reference to Test Case

An IA Controls Cross Reference to Test Case 318 defines a cross reference relationship between an IA control 212 and one or more test cases 222. This cross reference 318 is created by the Test Case Editor.

8) IA Subjects

An IA subject 314 defines the subject areas for each IA control 212 and is created and managed by the IA Control Manager.

9) Impact Codes

An impact code 316 represents an identified value of an impact of an IA control 212 on a system 206. The impact code 316 can be represented by such indications as High, Medium, or Low. The impact codes 316 are utilized by the IA control 212 Manager.

10) Category

A category 320 defines the importance level of a test case 222. In one embodiment this can be a rating where an “I” is the most important and an “IV” is the least important of the available categories 320. The category 320 can be utilized by the Test Plan Editor and each test case 222 can be defined within a category 320.

11) Classifications

A classification 208 represents the value for the classifications 208 of an IA control 212 or system 206 and denotes the degree of protection required for an IA control 212 or system 206, e.g.,. Classified, Sensitive, Public or Custom, by ways of example. The IA Control Manager and the System Manager utilize the classification 208 in their processes. In some embodiments, the AC&A System 100 can provide multiple classification modes. For example, in one embodiment the AC&A System 100 has three classification modes: unclassified, test, and secret. Unclassified mode can be the “normal” operating classification of the AC&A System 100 on the low side and can be used primarily for entering and updating the test plans. On the classified target computer system, the normal operating mode can be “secret” and the functionality can be slightly different. All processing and reporting of findings is performed on the classified target computer system. The test mode provides for testing of high side functionality while on the unclassified target computer system. No classified information can be entered on the unclassified network. All test data can be logged against the C&A test lab system so that no potentially classified information can be entered on the unclassified network.

12) Classifications Cross Reference to an IA Control

A Classifications Cross Reference to an IA Control 310 defines a cross reference relationship between the classifications 208 and IA controls 212 entities. Typically when an IA control 212 is created by the IA Control Manager, a cross reference is created between that particular IA control 212 and a classification 208.

13) Comments

A comment 218 is used to track textual comments made on a result 220 or test event 216 by a user 202 such as tester user 202. The comment 218 is typically performed by the Test Event Manager responsive to a user 202.

14) Results

A result 220 is an outcome of a test case 222 tested within a test event 216 on a system 206 or a machine within a system 206. Each result 220 has one or more findings 336, a program management 338, and can include comments 218. A result 220 is associated with each test event 216 and each test case 222.

15) Findings

A finding 336 describes the results 220 of running a test case 222 on a system 206 as part of a test event 216. Findings 336 are created and managed by the Test Event Manager. Each finding 336 includes the name or names of each machine of a system 206 that was tested. The result 220 of the test performed on each machine of each system 206 is included in the finding 336. The findings 336 can also include an indication if the particular finding 336 was a system wide finding or a machine specific finding. Additionally, the finding 336 can include an indicator as to whether test on the machine or system 206 passed or failed, e.g., the result 220 was consistent with the expected result of the requirement.

Findings 336 can also be imported from remote systems or received via an input interface, such as via an XML STIG file. Such findings 336 are then stored by the AC&A System 100. Any import errors of the findings 336 can be recorded as an import error 334.

Where a test event 216 is published, the findings 336 can be displayed for all systems 206 where the user 202 is a member of the system 206.

The findings 336 can, for example, be filtered to only show failures, to show a machine name, an actual result, whether or not it failed, and whether or not it is system 206 wide are all required when adding a finding 336.

16) Test Event Manager: Findings Report

The findings report parameter cab display findings data from the results cross reference and findings parameters. This can include, for example, findings 336 of duplicated machines such as two using the same machine name, the number of failed findings per test plan 224, the number of failed findings 336 for each category 320 and the total number of failed findings 336, and any errors encountered during the importation of the findings 336.

17) Import Files

An import files 332 is used to store any output files from remote systems that are a result of a test and can include importations from the users 202 as well as from the system 206, or possibly any third party system. The Test Event Manager creates the import files 332 in association with the test event 216 and provides for the storing of the received findings 336 where imported via a document or file. Import files 332 typically have zero or more import errors 334 and are associated with particular test events 216. When import files 332 includes importing findings 336 via an XML data file, such import can populate results 220 and findings 336 into the Results Cross Reference to Findings. The process can occur asynchronously updating a label on the test event 216 parameter with the current status.

18) Import Errors

An import error 334 defines any errors that occurred during the importation of findings 336 such as through import files 332, by way of example. The import errors 334 is created and managed by the Test Event Manager. Each import error 334 can be provided with a vulnerability 328, a title from the Security Readiness Review (SRR) script, and a status of the associated finding 336 such as being Open, Closed, or Unknown. Additionally, the import error 334 can include an identification of the machine name of a system 206 associated with the test case 222. The import error 334 is associated with an import file 332.

19) MAC Levels

MAC levels 210 are mission assurance categories (MAC) that represent the values of an IA control 212 or system 206. The MAC levels 210 are utilized by the IA Control Manager and the System Manager. Each system 206 can include a MAC level 210.

20) MAC Levels Cross Reference to IA Controls

MAC Levels Cross Reference to IA Controls 308 defines a cross reference relationship between the MAC levels 210 and IA control 212 entities. The System Manager creates and manages the MAC level 210 cross reference to the IA controls 212. 21) Reports

A Reports capability provides the output of the AC&A System 100 to provide the findings 336. These reports can be generated once a test event 216 is completed and the findings 336 are complete or on a demand basis. A report with the findings 336 can include a Scorecard, POA&M, and/or test plan 224 details as defined by the IA control 212. The report can be of any format and can include common spreadsheet output format or data files that can comply with user needs or requirements or Source Documents, such as industry standards, user specifications, by way of examples such as, one specific example of compliance with DOD 8510.1 DIACAP. In some embodiments, the reports can be formatted and transmitted via electronic interfaces including via electronic mail to pre-established addressees. For example, in one embodiment upon publication of a test event 216, all users 202 of the AC&A System 100 associated with a particular test event 216 can be provided an email notifying them of the publication of the test event 216.

22) Program Management

A program management 338 defines data associated with failed or failures within a test events 216, e.g., a failed finding 336. The Test Event Manager creates and manages the program management 338. The program management 338 can include a point of contact, an estimated cost of the resources required to address the failure, the scheduled completion date for correction of the failure, the initial milestone, the mitigation response to the milestone, and the status of the plan of action, such as Open, Closed, and Ongoing. Each program management 338 can have zero or more milestone changes 340 and is associated with a result 220.

Program management 338 is typically only available following the publishing of a test event 216, as that is when a finding 336 is determined to have failed.

23) Milestone Changes

A milestone change 340 tracks the changes to the milestones set under program management 338. The milestone changes 340 are created and managed by the Test Event Manager.

24) Results Cross Reference

A results cross reference 220 (as defined herein also generically simply as results 220) can include a cross referencing of the results 220 to a test case 222 within a test event 216. This includes cross-references between findings 336, program management 338, comments 218, test events 216, and test cases 222. The Test Event Manager creates, manages, and utilizes the results cross reference 220.

25) Roles

A role 204 defines the access a user 202 has to different parts, functions and capabilities of the AC&A System 100. This is usually created by the User Manager as a system administrator function and provided with a unique name. The SA DBA and Test Plan Editor are Administrative roles. The Program Manager, Tester, and Reviewer are AC&A System roles.

26) Source Documents

Source documents 324 are documents that define the requirements for a test case 222. The Source Document Manager creates and manages the source documents 324 when received by the AC&A System 100. The Source Document Manager and the Test Event Manager utilize the source documents 324. The source documents 324 include a unique identifier and the name of the actual source or document or reference number, the version of the source document, and the date of the source document. Typically source documents 324 are also referenced by the test references 326. Source documents 324 can be viewed, added, edited or deleted. In some embodiments, a source document 324 can only be deleted if it is not tied to a test reference 326 at the time.

27) System Notes

System notes 214 provide for additional information related to test cases 222 that are to a specific system 206. The Test Case Editor creates, manages and utilizes the system notes 214. Each system note 214 can be associated with a particular system 206 and a particular test case 222.

28) Test Cases

Test cases 222 contain all the information needed to execute a specific test of a requirement against a system 206. Each test case 222 is created, managed and utilized by the Test Case Editor. The Test Plan Editor, Test Event Manager and the Reports entities also utilize the test cases 222. Each test case 222 can include a requirement (Predetermined requirement) such as may have been defined by a Source Document, Test Reference, or otherwise. The test case 222 also includes a Test Action that defines the process steps associated testing to determine compliance with the requirement such as compliance with the Expected results 220 from the Test Action. Additionally, the test case 222 can include notes associated with the test case 222, a Test Case Status indicator as to whether the test case 222 is Active or Inactive and a Category Identification to indicate a category 320 of the test case 222. In one embodiment, each Test case 222 has the following relationships: one category 320, zero or more IA controls 212, zero or more test questions 322, zero or more test references 326, zero or more system notes 214, and zero or more results 220. Each test case 222 can be associated with a test plan 224 including a Custom Test Plan 226.

Each of the parameters and data fields within the test case 222 can be added, deleted, or edited. However, a Reference 326 can only be deleted if it is not the principle reference of the test case 222. Test cases 222 can be searched by Title or Reference 326 and can be filtered in the search by the test plan 224, test event 216, Title, and Reference 326.

29) Test Events

A test event 216 is defined when a system 206 is tested. The test event 216 is used to describe when and by whom a system 206 was tested as well as the findings 336 of the test. Each test event 216 is created and managed by the Test Event Manager. The Test Event Manager and the Reports utilize the test events 216. Each test event 216 can include a system 206 (or machine within a system 206) identification, the name of the test event 216, the date the test event 216 started, the date the test event 216 ended, and indicate whether the test event 216 is a baseline test for the system 206 and whether the test event 216 has been published. Typically each test event 216 can include zero or more results 220, one or more users 202, zero or more import files 332 and is on a per system 206 basis.

As noted, some test events 216 can be identified as Baseline test events. These Baseline Test events 216 can be marked as such. The Baseline indicator can indicate that this test event 216 is a complete system 206 test and that all of its findings 336, program management 338, and comments 218 can be used for Reporting purposes on this test event 216 and subsequent test events 216 until the next Baseline test event 216 is created. Non-Baseline test events 216 can use the program management 338 and comments 218 of the last Baseline test event 216 as well as merge the findings 336 from the last Baseline test event 216 and subsequent test events 216.

30) Test Events Cross Reference to Users

Test events Cross Reference to Users 304 define a cross reference relationship with each test events 216 and one or more users 202 of the AC&A System 100. The Test Event Manager creates, manages, and utilizes this Cross Reference 304. Each Cross Reference 304 includes an identification of the associated test event 216 and an identification of the user 202.

The Test Event Manager can view all test events 216 associated with each user 202 from the test events 216 parameter. Test events 216 can be published, but these may be restricted by role 204 or user 202 based on this Cross Reference 304.

31) Test Plans

Test plans 224 are logical collections of test cases 222. A Test plan 224 may have zero or one or more test cases 222. A Test Plan Manager creates, modifies and utilizes the test plans 224 for compliance testing coordination and planning. Each test plan 224 includes a name, the date the test plan 224 was assigned to a user 202, the date that the test plan 224 was last updated, an identification of the user 202 assigned to update the test plan 224, a flag to indicate that the test plan 224 has been validated, and a value that indicates if the test plan 224 has been updated. Test plans 224 may also be customized by a user 202; these are referred herein as Custom Test Plans 226.

Test cases 222 can be added, edited or deleted from the test plan 224. When a test plan 224 is selected, it can be exported via an output interface to a remote system. Any suitable or desired format can be utilized for such exporting.

A Test Plan Status section can provide documentation of the status of updates to existing test plans 224. For example, it can provide for the identity of the assignee, the date assigned and last update dates. When completed and reviewed, the AC&A System 100 can update the Updated field (see below) indicator. The test plan 224 Status section includes, but is not limited to, various user 202 functions. Some of those functions that can be included include: an application function; an updated field; an assigned to function; a date assigned function; a last updated function; and an export status function. The application function can display the name of the Test Plan. Generally, the System 100 can have a single entry or listing for each test plan 224 contained in the certification and accreditation system. The updated field can indicate the test plan 224 has been completely updated to match the most recent STIG/Checklist. The assigned to function can indicate a person or group who is currently tasked with working on a particular test plan. A name in the block indicates the specific person or group is assigned to update the test plan 224 in accordance with the latest STIG/Checklist. A “name-review” indicates that the changes have been completed and the person listed is doing a peer review of the test plan. This indicates to the reviewer that the test plan 224 is ready to be peer reviewed. The date assigned function can be automatically updated with the current date whenever the “Assigned to” function is changed. The last updated function can be automatically updated with the current date whenever the “Updated” field is checked. The export status function, when activated, can create a snapshot of the Test Plan Status and can save it in a user's predetermined folder.

32) Test Plans Cross Reference to Test Cases

Test Plans Cross Reference to Test cases 330 defines a cross reference relationship with the test plans 224 and the test cases 222. The Test Plan Manager creates, manages and utilizes this Cross Reference 330 to identify one or more test cases 222 with each test plan 224.

33) Test Questions

Test questions 322 pertain to a particular test case 222. Test questions 322 are created, managed and utilized by the Test Case Editor. Each test question 322 includes text that relates to a particular test case 222.

34) Test References

Test references 326 or references can include a reference to the source of the test and can include a reference to a source document 324. Additionally, the test reference 326 can include a vulnerability 328 that relates to a particular test case 222. The Test Case Editor creates, manages and utilizes the test reference 326. Each test reference 326 includes an indicator to uniquely identify the Reference 326, uniquely identifies the test case 222, and provides an indication whether the Reference is a principle reference for the particular test case 222. Additionally, the test reference 326 can include an identification of the source document 324 including the name, date and version thereof from which the test reference 326 originated or was provided.

35) Users Cross Reference to Systems and Roles

Users Cross Reference to Systems and Roles 302 defines a cross-reference relationship between users 202 of the AC&A System 100, their defined roles 204 and each system 206. The User Manager creates, manages and utilizes this Cross Reference 302. Each Cross Reference 302 includes an identification of the user 202, the role 204, and the system 206.

36) Vulnerability

A vulnerability 328 defines the specific item referenced in a source document 324 for each test case 222. The Test Case Editor creates, manages and utilizes the vulnerability 328. The vulnerability 328 can be any indication and in some embodiments includes a Vulnerability Management System (VMS) number, or the prior Potential Discrepancy Item (PDI), Short Description Identifier (SDID), by way of examples, to identify the vulnerability 328.

37) Quality Assurance

Quality Assurance can be provided on the AC&A System 100. For example, there may be test references 326 that are reused, rather than replaced, or that may have multiple instances thereof. In such cases, a Reused References Report can be generated. Other such characteristics that can be tracked and reported can include an indication where a test case 222 has no principle test reference 326, test cases 222 with no IA control 212 assigned, and test cases 222 having multiple principles test references 326, by way of example. Other reports and system operations quality functionality can be developed as per the particular application as known to those skilled in the art.

A Q/A reports section can provide a reporting capability, alerting the C&A team to potential problems with test plans 224. The Q/A Reports section can include, but is not limited to, various user 202 functions and reports. Some of those functions and reports include, but are not limited to, a continuity notes function, a reused principle references function, a reused references function, a no principle reference function, a no IA controls 212 assigned function, and a multiple principle references function.

The continuity notes function can allow for annotation of anomalous entries in the certification and accreditation system. In one embodiment, a Solaris check GO 19 can be a single check or can be multiple checks. This reference number will show up on the Reused Reference report, but annotating can provide for continuity between team members

The reused principle references report can provide a list of principle references that are reused in the certification and accreditation system. Principle test references 326 may not be reused under any circumstances. Principle test references 326 can be the reference that shows up in the findings report. It can be provided such that it is the only way to track a finding by a specific number. Reusing principle test references 326 can cause confusion, as well as violate integrity rules. This report can highlight these violations. The reused references report can provide a list of references that are reused in the certification and accreditation system. In some embodiments, such references are not be reused, unless annotated in the maintenance notes section of the maintenance menu. Reuse of test references 326 can lead to confusion when trying to find a specific test case 222.

The no principle reference report can provide a list of test cases 222 that have not been assigned a principle test reference 326. Principle test references 326 can be test references 326 that show up in the findings report. It can be the only way to track a finding by a specific number. The no IA controls 212 assigned report can provide a list of test cases 222 that do not have any IA controls 212 assigned to them. The multiple principle references report can provide a list of test cases 222 that have multiple principle test references 326 assigned. Multiple principle test references 326 can be allowed, but are often limited as much as possible, as principle references show up on the findings report, and multiple test references 326 can lead to user 202 confusion.

### AC&A System Modules/Applications

A systems 206 provides the user 202 with the ability to add and list test events 216 for the selected target asset 206. A test event 216 (see below) section can be provided such that it is only visible on the secret and test systems. The systems 206 section can include, but is not limited to, various user 202 functions. Some of those functions can include a target computer system 206 name function; an add system 206 function; an applicable IA controls 212 function; a test events 216 function; and an add test event 216 function. The system 206 name function can enable a user 202 to select the desired target computer system 206 name from the drop-down list to populate the rest of the screen. The add system function can allow a user 202 to add a desired target computer system 206 by responding to the prompt with the system 206 name if the desired system 206 does not appear in the drop-down list. The applicable IA controls 212 function can list the IA controls 212 that are applicable to the system. This list can be based on MAC level 210 and classification. The test events 216 function lists the test events 216 that are stored in the AC&A System 100, with the most current event listed first. This section can be only visible if the AC&A System 100 classification 208 is either secret or test. The add test event 216 function can provide the ability to add new test events 216. This can be configured to only be visible to a user 202 if the certification and accreditation System 100 classification 208 is either secret or test. Once activated, the add test event 216 function can include multiple informational fields. Those fields can include a target asset or system name, selected from a drop-down list; a test name; a test start date; a test end date; and a tester list, made from testers who participated in the test event 216.

An IA Controls application and provides detailed information about the IA controls 212. The IA control 212 section can include, but is not limited to, various user 202 functions. Some of those functions can include an IA control 212 function, a subject text function, an impact code function, a control name function, a control text function, and a vulnerability text function. In one embodiment, the IA control 212 consists of the 8500.2 IA control. The subject text function contains the subject text of the listed IA control 212. The impact code function identifies the impact code of the IA control 212. One example can consist of a high, a medium, or a low identifier. The control name function can provide the IA control 212 name while the control text function lists the IA controls 212 requirement. The vulnerability text function can provide vulnerabilities associated with the specific IA control 212.

An Event Reports application can provide a summary of the findings by the test event. In some embodiments, this can be made visible only where the AC&A System 100 classification is either secret or test. The Event Reports can include, but is not limited to, various user 202 functions. Some of those functions can include a test event 216 function, a duplicate machine entries function, an application counts function, a category counts function, a findings report function, a testers addendum function, a findings not imported function, and a VMS XML import function. The test event 216 function can enable a user 202 to select the desired test event 216 in this list to view the summary of findings 336. The duplicate machine entries function can indicate whether the XML file had the same machine name listed multiple times for a given test case. In some embodiments, this is generally cleared before a findings 336 report is generated. A user 202 of the AC&A System 100 can review each test case 222 listed and can remove duplicate findings where required or desired. The application counts function can list the number of findings for each test plan, broken down by category level. The category counts function can list the number of findings for each category level, as well as the total number of findings.

### AC&A Event Report Functions

The Findings Report application of the AC&A System 100 can generate a findings 336 report but such a generation can be limited to where there are no duplicate machine entries that are yet to be resolved. In one embodiment, the findings 336 report generated can be a known spreadsheet formatted document listing each test plan 224 along with the findings 336 for each test case 222. The report can be output to user 202 or saved and sent to predetermined folder or directory.

The tester's addendum function can be available after the findings 336 report has been generated. This function can generate a tester's addendum document that contains additional information for each test case 222 found in the findings 336 report. This additional information can include the principle reference, title, requirement, notes, and system notes 214.

The findings 336 not imported function provides a list of findings that were not imported directly into the AC&A System 100 from the XML import routines. Some reasons for items being listed here can be either the XML file did not have a reference number for the findings 336 or the AC&A System 100 does not have the specific reference number assigned to a test case 222.

The VMS XML import application can run the import routine coded specifically for a Gold Disc XML or UNIX SRR (Security Readiness Review) XML file. This can be configured to the tested periodically or on the occurrence of a particular event such as when there is a new Gold Disc or UNIX SRR released to ensure the import routine does not need to be updated.

### AC&A Test Plans

Test plans 224 are developed and maintained for each target asset such as each computer system to be tested. A test plan 224 can be developed for every application and OS running on the supported target computer systems. When new applications are added to the baseline, a new test plan 224 can be developed. The appropriate STIG and checklist are downloaded from the Defense Information systems Agency (DISA) Information Assurance Support Environment (IASE) site and used in filling in the required information.

To begin a test plan 224 build, from the main menu of the user 202 interface, the AC&A System 100 can be configured for a user 202 to select Test Pans. On the test plans 224 master window, the user 202 can select add test plan 224 and enter the name of the new test plan. Once created, the user 202 can select it from the drop down list to begin data entry. Generally, data can be entered top to bottom, left to right. Since certain fields are required, a failure to fill in that information can result 220 in a warning message. If the user 202 wants to continue, the user 202 can simply accept the warning message and enter the data to continue. Generally, in some embodiments, not all fields are required, for example the Questions and Notes fields. After completing the Test Plan, the user 202 can run the reports under Q/A Reports to ensure there are no problems with the Test Plan.

When updates to the STIG and/or checklist are released, corresponding updates are applied to the certification and accreditation system. When updating a test plan 224, a test references 326 listing must be updated as well to reflect the new version and date. After updates are completed, the test plan status can be updated to reflect the assigned reviewer. After updating the test plan 224, the reports can be run under Q/A Reports to ensure there are no problems with the test plan 224.

Prior to on-site testing, the appropriate test plans 224 and associated questions are obtained by exporting them to an appropriate directory. These capabilities are provided on the test plans window. The tester user 202 can then forward the questions to the command, giving them time to respond prior to the on-site testing. Frequently testers may print out the test plans 224 and burn a CD containing the test plans 224 as well as the appropriate STIGs and checklists to use as references on-site.

If the test plan 224 of the AC&A System 100 is more current than another version, a user 202 can port the test plan 224 to the other network. The user 202 interface portion of the AC&A System 100 can be copied over as well. Generally, AC&A System 100 can provide for limiting the ability of a user 202 to overwrite files contains the actual C&A findings 336, the test events 216, as such can be protected for future reference.

New test events 216 can also be added on the systems window. Test event findings 336 can be entered on the findings tab of the test plan window. When developing and updating test plans 224, the Q/A reports are used to validate that the data is complete. After test events 216 have been completed, the report on the findings 336 can be generated from the Findings Report window. A Testers Addendum report may also be generated from this window.

A test plans module or feature of the AC&A System 100 can provide the ability to manage the test plans 224. When a test element is selected, one or more the test references 326 can be displayed on the user interface of the AC&A System 100. The user interface also has functions to assist in selecting the desired test plan 224 or test element. Other portions of the AC&A user interface can be used for entering or displaying the test case information.

The AC&A System 100 can include, but is not limited to, various user functions. Some of those functions include: Show Test Plan; Add Test Plan; Search By Title; Search By Reference; Select test event; Clear Search; Validation Plan; Title; Application Name; Category; Export Test Plan; Export Questions; Delete Me!; Include in Validation Plan; and Include entire test plan in Validation Plan.

The Show Test Plan function provides the ability to select the desired test plan, bringing it up for viewing and/or editing. The test plan 224 can be selected from a drop down list or typed in the appropriate designated area. The Add Test Plan function allows the user 202 to add a new application (test plan 224) to the AC&A System 100 if the test plan 224 does not exist. Once added, it will be available from the “Show Test Plan” drop down, and test cases 222 can then be assigned to it. The Search by Title function provides the ability to search the AC&A System 100 for a specific title by entering the desired title or selecting it from the drop down list. The Search by Reference function provides the ability to search the AC&A System 100 for a specific test reference 326 by entering the reference or selecting it from the drop down.

The Select Test Event function can provide the ability to show all test cases 222 for a specific test event 216 that have findings 336 associated with them. This can only be visible if the classification mode of the AC&A System 100 is set to secret or test. The Clear Search function can be used to clear any search a criterion that has been entered into the search boxes.

The Validation Plan function of the test plan 224 may include two separate functions within it. A Clear Flags function clears any existing validation flags in the certification and accreditation system. This can be done prior to setting the flags on test cases 222 when creating a new Validation/Manual Test Plan. Another function of the Validation Plan can be an Export Report function. The Export Report function exports the Validation/Manual Test plan. This includes any test cases 222 that have the “Include in Validation Plan” checked. The report can be exported to the user's predetermined folder.

The Title function of the test plan 224 can provide the title of the test case. The Application Name can provide the test plan 224 to which the test case 222 is assigned, while the category function can provide the specific category assigned to the test case. The Export Test Plan function can export the currently selected application test plan. The file can then be saved to a user's predetermined folder. The Export Questions function can be used when information is gathered prior to the on-site test. When the test case 222 is developed, these requests are documented on the Questions tab of the test plan user interface. This function exports the currently selected application test plan questions so they can be forwarded to the command. The file then can be saved to the user's predetermined folder. The Delete Me! Function flags the test case 222 to be hidden from view. This can include all screen faces and reports. The record is not truly deleted, as it is still in the certification and accreditation system. The function removes it from view and maintains it as historical data for each of the previous test events. The Include in Validation Plan flag indicates the test case 222 should be included in the Validation/Manual Test Plan while the Include Entire Test Plan in Validation Plan flag automatically assigns all test cases 222 assigned to the currently selected application (test plan) to the Validation/Manual Test Plan.

### Exemplary AC&A Test Plan User Interface Controls

A Test Plans requirements tab of the test plans user interface can be used to enter and maintain the STIG requirement information. It can include a Test Plan requirements indication and identification of the IA controls 212. A Test Plans requirements tab can include a requirement field, an IAVA format field, and an IA controls area. The requirement field can contain the STIG requirements while the IAVA format field provides additional information pertaining to IAVA Test Plans. The IAVA format field can only be visible if the “Show Test Plan” drop down box indicates the IAVA Test Plan. The IAVA format field introduces the test plan lava information. The lava information includes, but is not limited to, a title, which provides general guidelines for what can be contained in an IAVA Test Plan title; requirements, which indentifies three formats available for the requirement field of the test plan 224 which are all formatted in a manner allowing the user 202 to make edits; and references, which provides guidelines for the References section of the IAVA test plan. The IA controls area of the Test Plans requirements tab can be used to assign IA controls 212 to the test case 222.

A Test Info tab of the test plans user interface may provide guidance to the tester regarding what action they should perform to validate the test case 222 and spells out the expected results. The application checklist frequently spells these out and can be used here with minor modifications. The Test Info tab includes, but is not limited to, a Test Action block and an expected result. The Test Action block contains the test action required to perform the specific test. If the specific actions are lengthy, a summation of the test actions are placed in this field and the detailed actions placed into a Notes tab (see below). The expected results details what the expected results of the Test Action are. They can be specific enough to leave no doubt as to the status of a particular finding.

A Test Plans Questions tab of the Test Plans user interface can be where questions can be assigned to a specific test case. These questions are sent out prior to a test event, and can be answered by the Program Management Office (PMO) or their delegate. The answers may aid in performing an accurate and timely test event.

A Test Plans Reference tab of the Test Plans user interface identifies all test references 326 for the test case 222. Frequently, the test references 326 are identified in the STIG and/or checklist. In some embodiments, as known in the art, a Gold Disc can be used to obtain the test reference 326. If there is a conflict, the more recent source document 324 takes precedence. One test reference 326 can be flagged as the Principle Reference by checking the appropriate box. The test plans test reference 326 contains several functions that can include, but are not limited to, a Test References function, a Source Document function, a principal Test Reference function, and a modify source list screen. The Test Reference function lists all Reference numbers from the various source documents 324. The source document 324 identifies the document the test reference 326 originated. The user 202 may select the appropriate document from the drop-down list and if it is not there, the user 202 may use “Modify Source List” to add it. The principal reference function indicates that the reference is the most currently available reference from DISA. References marked as being a principle reference will show up on exported reports.

The modify source list screen tab lists the various sources used in creating the test plans. The version number and date should be updated whenever changes in the source document are updated in the test plans. If the document is not listed, the user 202 can be prompted to enter the Source Name, Version and Date on the next available blank line. It will then be available for use from the drop-down menu. The modify source list screen provides users with source name of a document, a version of the source document, and a date of the source document.

A Test Plans Notes (Unclass) section of the Test Plans user interface can be an area provided for additional information that supports the specific test case. Extended test actions, lists of vulnerable software, by ways of example, can be placed here.

A Test Plans System Notes of the Test Plans user interface can provide for placement of notes that are specific to a system. The tab can be provided such that it is only visible if the database classification is either secret or test. Only one note per system 206 per test case 222 can be allowed in some embodiments. The user 202 may select the target asset or system 206 from the drop down list, and then enter the note into the larger field. These notes may show up on the tester's Addendum report.

A Test Plans Findings tab of the Test Plans user interface can be used to document the findings on the classified network. It can only be visible if the AC&A System 100 classification is either secret or test. The Test Plans Findings tab contains several functions which include, but are not limited to, a select test event function, a default machine name function, a machine name function, an actual result function, a fail function, and a system wide function. The select test event function can identify the test event 216 to which the findings belong. The default machine name function can enable a user 202 to put a machine name in this block and then the machine name block will change to this default entered after the first finding is entered. The machine name function presents the machine with which the finding is associated. The actual result can be a field used to document the details of what was found on the test machine. The fail function indicates whether the test case 222 failed. If the fail box is checked, the test failed. An unchecked fail box indicates that the test passed or it is not a finding. The system wide function allows a user 202 to check the system wide box which then changes the machine name to system wide. This can be for findings that apply across the entire system and are not specific to a single machine or group of machines.

In another embodiment of the Test Plans Editor workflow, the Test Plans Editor can create and edited test plans 224. When a new or updated requirement such as a checklist is received, there may be a need for a modification to an existing test case or test plan or may require the creation of an entirely new test case or test plan.

Where the later, e.g., a change to an existing test case or test plan, the associated test plan status changes to “not updated.” The test plan is assigned to “test plan modifier” who is responsible for updating the test plan based on the new requirement. First, an identification of what changed must be determined. Then the test case or plan can be updated or modified, or it could be determined that the changes were significant and actually a new test case or test plan is required after all. Typically, a search and/or research is performed to identify information as the source documents are is sometimes insufficient to create a comprehensive test case due to the lack of specific technical data. The test plan modifier must research solutions to be in compliance with the predetermined requirement. At this time the test plan status changes to “review.” At this time the modified test plan can be assigned to reviewer. If the review fails the quality assurance (ZA) check by the reviewer, then workflow returns to the modifier for correction. If the review passes the QA, the test plan status changes to “updated” and is available to compliance testing, e.g., test events.

Where a new test case or plan is required, similar research is performed and the new test case or test plan is created as described above. After the new test case or test plan is prepared, its status is changed to “review.” It is then assigned to reviewer for similar QA.

### Exemplary Method for a New Source Document

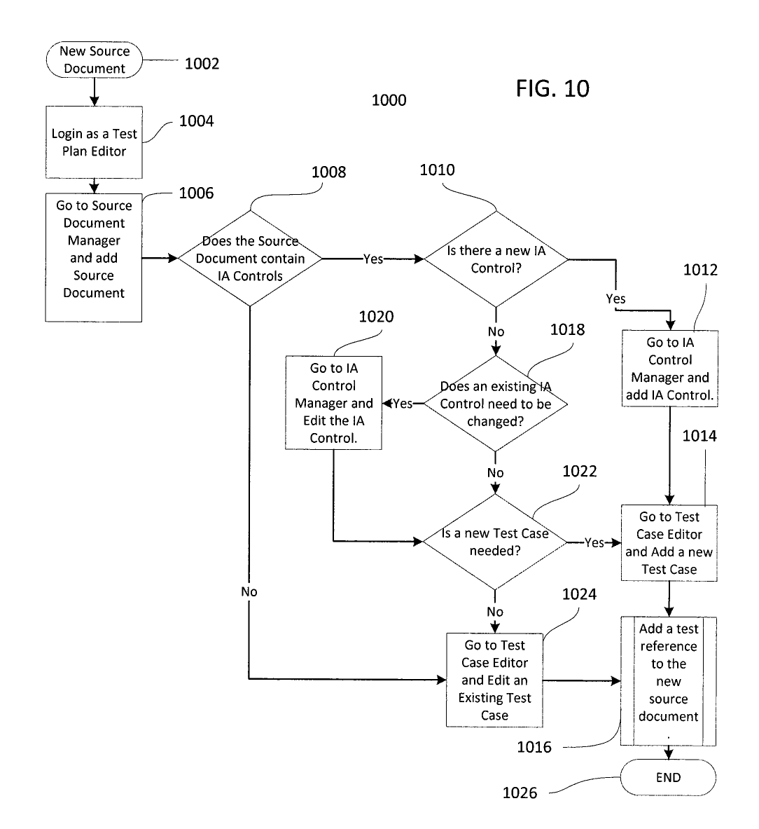

FIG. 10 illustrates one exemplary method 1000 for adding a new source document 324 to the AC&A System 100. As shown the method 1000 starts with receipt of a new source document 324 at process 1002. A user 202 logs onto the system 100 and enters the Test Plan Editor application or function at process 1004. The user 202 next goes to the Source Document Manager and selects to add a new source document 324 in process 1006. The Test Plan Editor and/or the user 202 determine whether the new source document 324 contains one or more IA controls 212 in process 1008. If it contains IA controls 212, the method goes to process 1010 to determine if the IA control 212 contained in the new source document 324 is a new IA control 212 or an existing IA control 212, e.g., new to the SG&A System 100.

If the IA control 212 is a new IA control 212, the method goes to process 1012 for the addition of the IA control 212. After the new IA control 212 is added by the IA Control Manager, the method continues to the Test Case Editor in 1014 that adds a new test case 222 to the new IA control 212. In 1016, a new test reference 326 is added to the new test case 222 that relates the test case 222 back to the source document 324. After this is performed, the method ends at 1026.

However, where there is one or more IA controls 212, but not any new IA controls 212 as determined in process 1010, process 1018 determines whether an existing IA control 212 needs to be changed. If an existing IA control 212 needs to be changed, the method goes to process 1020 wherein the IA Control Manager provides for editing of the existing IA control 212 as necessary for the new source document 324. Regardless of whether an existing IA Control needs to be changed, the process where a new IA Control is not present, results in process 1022 with a determination of whether a new test case 222 is needed based on the new source document 324. If a new test case 222 is needed in process 1022, the method goes to process 1014 and the method continues as described above. However, if a new Test Case is not required or needed in process 1022, the method goes to the Test Editor and the existing test case 222 is edited in process 1024 and the method continues to process 1016 as described above.

In the situations where the new source document 324 does not contain IA controls 212, the method goes directly to process 1024 and continues as described above therefrom.

### Exemplary Method for Adding a New System

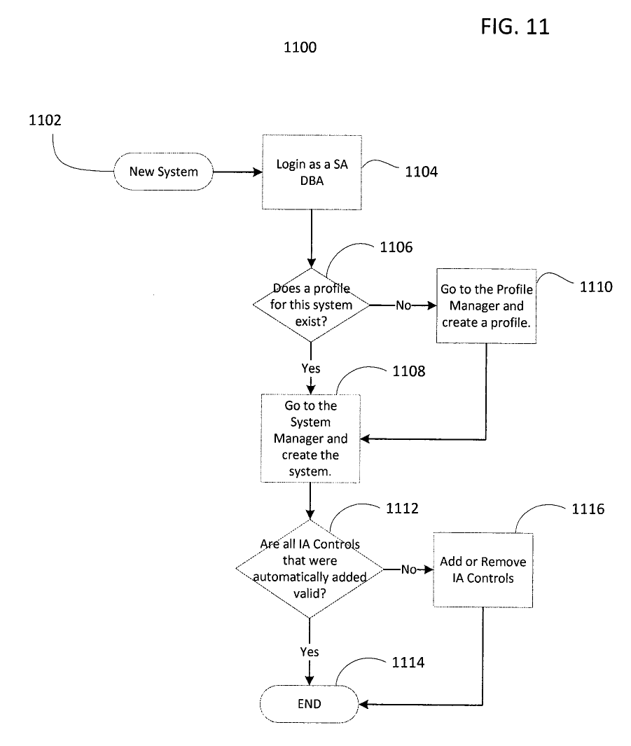

FIG. 11 illustrates one exemplary method 1100 of adding a new asset or system 206 to the AC&A System 100. A new system 206 is received at 1102 by a user 202. The user 202 logs onto the System 100 as a SA DBA in 1104. The system reviews to determine if an existing profile exists for the system 206. If a profile does not currently exist, the system goes to the Profile Manager to create a new profile for the new system 206 in process 1110. After a new profile is created in 1110, the method continues in 1108 by implementing the System Manager to create a new system 206. Similarly, if a profile already exists for the system 206, the method goes directly to process 1108. This includes automatically adding an associated IA controls 212.

After the new system is created in 1108, it is reviewed whether the system has all of the IA controls 212 and that such IA controls 212 are valid for that new system 206. If they are not, the method adds or removes the IA controls 212 as necessary in process 1116. After this, the new System method terminates in 1114. If all IA controls 212 were valid as determined in process 1112 that method immediately terminates in process 1114.

### Exemplary Method for Adding a New Test Event

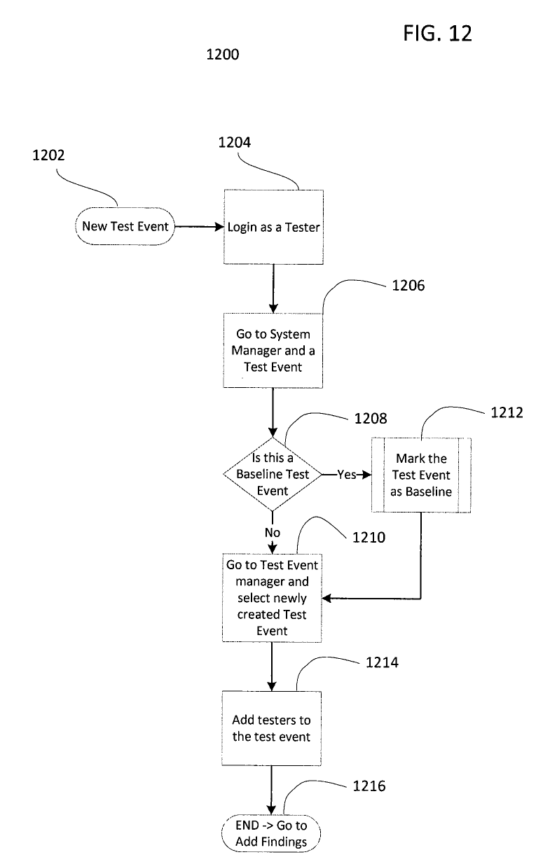

As shown in FIG. 12, a method 1200 provides for creating a new test event 216 within the System 100. The new test event 216 is received in process 1202. The user 202 logs onto the AC&A System 100 in 1204 and goes to the System Manager in 1206 to add the new test event 216. Next a determination is made as to whether the new test event 216 applies to an entire system 206 or applies to less than an entire system in process 1208. If the new test event 216 applies to an entire system 206, then it is determined to be a Baseline test event 216 and the process is marked as such in 1212 and the method continues to the Test Event Manager in 1210. If it is not a Baseline test event 216, the method goes directly to the Test Event Manager in 1210. At the Test Event Manager in process 1210, a newly created test event 216 is created. Next in process 1214, tester users 202 are added to the test event 216. The method then transfers over to Add Findings or Results in process 1216.

### Exemplary Method for Performing Tests and Adding Results

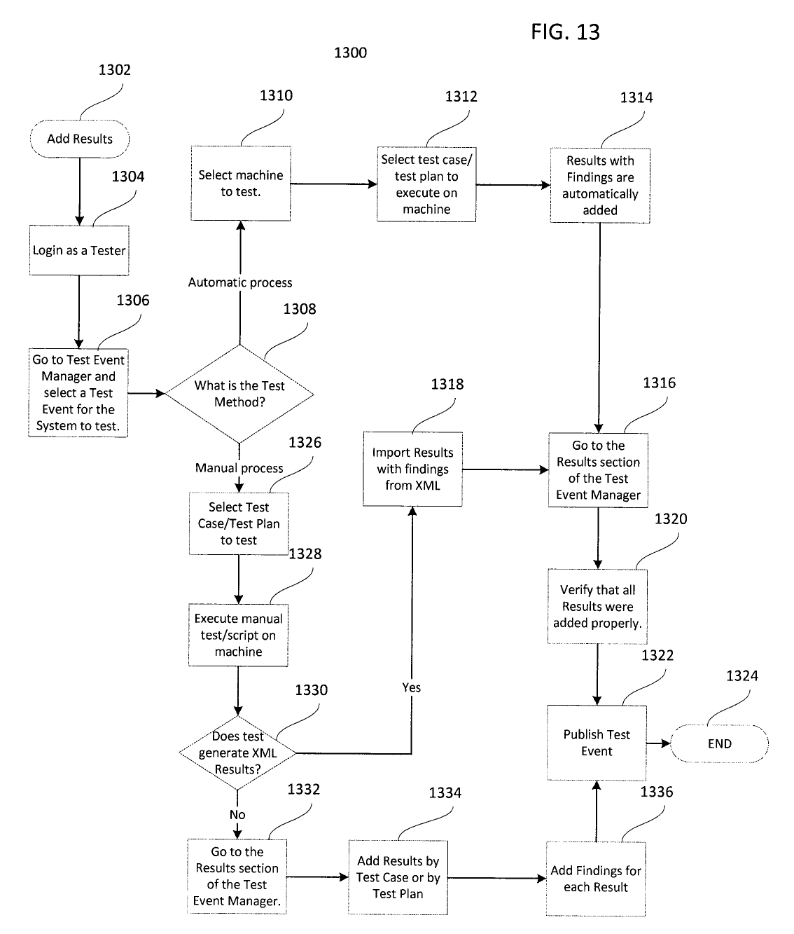

New results 220 can be added into the system as illustrated by the New Results method 1300 as shown in FIG. 13. A new result 220 is received at 1302 and the user 202 logs onto the AC&A System 100 at 1304 as a tester user 202. The method then provides for the Test Even Manager that enables the selection of a test event 216 to be performed in 1306. If the Test Method of the test case 222 or test plan 224 as required for the test event 216 is an automated method as determined in process 1308 an automated method continues to process 1310 wherein one or more machines within the system 206 is selected. After the machine is selected, a test case 222 and/or test plan 224 is selected to be executed on the selected machine in 1312. After the selected test case 222 or test plan 224 is performed on the selected machine, process 1314 provides for the automatic addition of the results 220 and findings 336 to be added. The method then continues to process 1316 where the Results are entered into the Results section of the Test Event Manager for the particular test event 216 associated with the results 220 of the immediate process. Afterwards, the results 220 are verified in 1320 to ensure that all results 220 were added properly. If the results 220 were added properly, the test event 216 is published in 1322 and thereafter ends at process 1324.

In the alternative to the automated method, wherein process 1308 determines that the method will be manual, e.g., performed by the tester user 202, in whole or in part, the method provides for the selection of the test case 222 and/or the test plan 224 in process 1326. The tester user 202 then initiates in 1328 the execution of the test or test script or scripts on a selected machine. The method continues at 1330 with the identification of whether the manual test of 1328 will result in the generation of an XML formatted output with the results 220 of the test. If the manual test of 1328 generates an XML Results, the method imports the XML file with the results 220 directly into the Test Event Manager of process 1316 and continues from there as described above. However, if the manual test of process 1328 does not create an XML output, the process 1330 goes to the Results section of the Test Event Manager in 1332 and the tester user 202 manually enters or adds the results of the manual test into the Results section of the Test Event Manager by Test Case and/or Test Plan in 1334. The method continues in 1336 by adding the findings 336 for each received result 220. The method continues to process 1322 where the test event 216 is published and the method ends at 1324.

### Exemplary Reporting Method

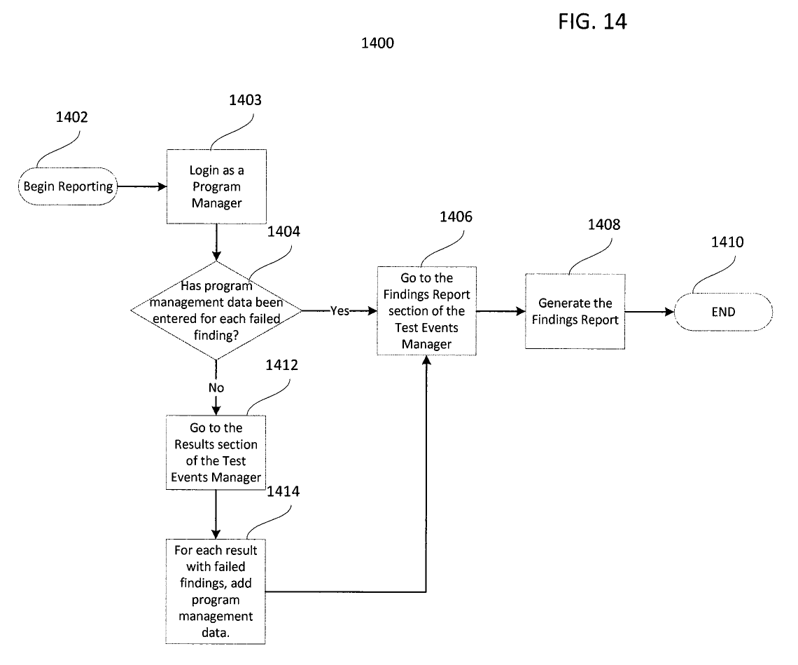

FIG. 14 illustrates a method 1400 for reporting the results as prepared by the AC&A System 100. Where a report is required, the method starts at 1402 and the user 202 logs onto the AC&A System 100 as a Program Manager in 1403. The first determination is made in process 1404 as to whether program management 338 includes data for each failed finding 336 for the test events 216. If the program management 338 includes data for each failed finding, the method continues to process 1406 wherein the Finding Report section of the test events Manager is actuated and the findings 336 are generated in a Findings Report in 1408. After the Finding Report is generated in 1408, the method terminates at 1410. However, where it is determined in process 1404 that the program management 338 does not include data for all of the failed findings of the test event 216, the method provides for process 1412 wherein the Test Event Manager is enabled in 1412 and for each result 220 that had a failed finding, that was not already in the program management 338, the user 220 must add the failed findings to the program management 338. After all of the failed findings are added, the method continues to process 1406 for continuing to the generation of the findings report in 1408.

In one embodiment the program management 338 can include receiving the Reports from web page or database and completing the Report with Program management proprietary and/or sensitive data. This is usually manually entered. This can include funding, points of contacts, and milestones that address the program management 338 identified test event 216 failures.

### Exemplary Tester User Workflow

A tester user 202 can perform a variety of methods in support of performing a validation test on a target asset for compliance to a predetermined requirement. Following is one exemplary such method.

Where a new system is fielded, the tester user 202 can change to the baseline of existing system causing security impact and attend to any necessary modifications, each of which are validated when complete. An ad hoc test plan can be created rather than rechecked. Specific test cases can be checked, collected into a new test plan 224 that shows only the test cases 222 that are desired and applicable. Test questions and test plans can be sent to the appropriate Program Management Office (PMO) for review. The test questions can be modifiers to an existing test case such that the test case can be evaluated and/or quantified. After this is approved, the tester user 202 can execute the test plan 224 or one or more test cases 222. This can include executing automatic tests on the target asset such as scripts that produce outputs and can include reports as well as comparisons to expected results for compliance and also Results and Findings in some embodiments. Additionally, the tester user 202 can perform manual tests on the target asset. These can be hand checked items which may or may not be able to be checked automatically.

The tester user 202 can gather any manual Results, log them and collect and generated results from the target assets whether manual or from automatic tests. These can be parsed and then imported into the AC&A System 100 to be stored and compiled as results 220, test events 216 and ultimately as findings 336. In some cases, this can include, in whole or in part, manually entering information is entered for specific system date, test event data, and test case data.

The tester user 202 can also perform an analysis on the received data to ensure that the received data is appropriate and applicable and valid. Comments can also be entered. After the Text Events 216 are complete and the findings 336 prepared by the AC&A System 100, Reports can be generated either automatically or upon command by the tester user 202 or another User 202. This typically includes generating Findings Reports and Program Management to the PMOs. This can include, by way of examples, a DIACAP scorecard, and a DIACAP POAM, such as mandated by DODI 8510 (to be in compliance with DIACAP activity 2). However, as those skilled in the art understand, any such formatting and reporting is possible and any required output format can be provided by the system as described herein.

The tester user 202 can also create a Tester's addendum that contains all of the research and notes of a given system, test case or test plan. This can be used to assist the tester or the PMO in the future. This can include, but is not limited to comprehensive listing of all checks performed, the STIGs affected by findings.

### Operating Implementation Environment

Various embodiments of the present disclosure can be embodied in the form of computer-implemented processes and apparatuses for practicing those processes. The present invention can also be embodied in the form of computer program code containing computer executable instructions embodied in tangible media, such as floppy diskettes, CD-ROMs, hard drives, or another computer readable storage medium, wherein, when the computer program code is loaded into, and executed by, an electronic device such as a computer, micro-processor or logic circuit, the device becomes an apparatus for practicing the invention.

Other embodiments can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

As described herein, the AC&A system 206 and methods can be implemented on any suitable hardware, firmware and software environment. In one exemplary embodiment the methods as described herein can be implemented in a Web 2.0 environment with a front-end web GUI and a back-end relational database residing on one or more servers. For example, in one embodiment of an AC&A System 100, the hardware system can be a single standard microprocessor based server with a quad core processor and 16 GB of RAM. The physical server will be virtualized into two virtual servers each utilizing two virtual processor cores and 4 GB of RAM. The SC&A software can be a web based application using Microsoft .Net 3.5 and Asp.Net for the front end and using NHibernate to connect to an Oracle database. To facilitate this, Microsoft Windows Server 2008 Enterprise (64-bit) edition can be used as the base OS on the physical server, with its only role 204 being Hyper-V virtualization. The first virtual server can be a web server and can use Microsoft Windows Server 2008 Enterprise (32-bit) edition with IIS 7.0. The second virtual server can be a database server and can use Microsoft Windows Server 2008 Enterprise (32-bit) edition with Oracle 11 g Standard One database server. Development tools can consist of Microsoft Visual Studio 2008, Oracle SQL Developer 1.5, and Microsoft Visual Source Safe 2005. The communications architecture for enabling users to access and/or connect to the AC&A system 206 can be a web application via the Internet using an SSL based connection. The web server can be the only Internet facing server with connection via a hardware router. The web server can have a firewall with only port 443 enabled for the SSL based connection. The web server can communicate with the database server using port 1521 over a virtual network.

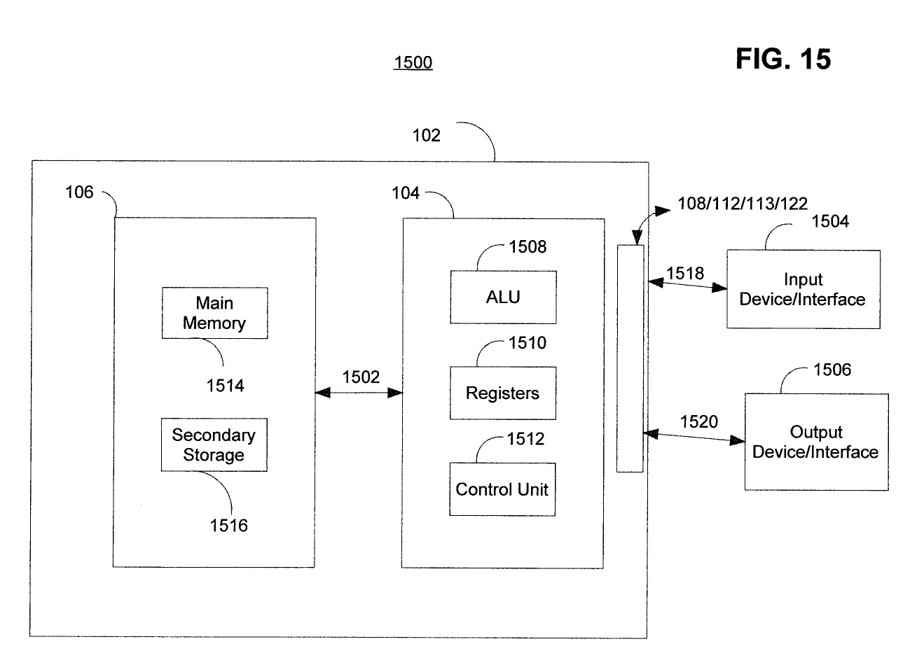

For example, referring to FIG. 15, one exemplary operating environment of the present disclosure includes a computer System 1500 with a computer 102 that comprises at least one high speed processing unit (CPU) 104, in conjunction with a memory System 106 interconnected with at least one bus structure 1502, an input device 1504, and an output device 1506. These elements are interconnected by at least one bus structure 1506

The illustrated CPU 104 can be of familiar design and includes an arithmetic logic unit (ALU) 1508 for performing computations, a collection of registers 1508 for temporary storage of data and instructions, and a control unit 1510 for controlling operation of the System 1500. Any of a variety of processors, including at least those from Digital Equipment, Sun, MIPS, Motorola, NEC, Intel, Cyrix, AMD, HP, and Nexgen, is equally preferred for the CPU X. The illustrated embodiment of the disclosure operates on an operating system designed to be portable to any of these processing platforms.

The memory system 106 generally includes high-speed main memory 1514 in the form of a medium such as random access memory (RAM) and read only memory (ROM) semiconductor devices, and secondary storage 1516 in the form of long term storage mediums such as floppy disks, hard disks, tape, CD-ROM, flash memory, by way of examples, that store data using electrical, magnetic, optical or other recording media. The main memory 1514 also can include video display memory for displaying images through a display device. Those skilled in the art will recognize that the memory system 106 can comprise a variety of alternative components having a variety of storage capacities.

The input/out interfaces 108, 112, 113, and 122 are any suitable interfaces including communications interfaces such as a Graphical user 202 Interface (UEI) or network interface. The input device 1504 and output device 1506 are also familiar. The input device 1504 can comprise a keyboard, a mouse, a physical transducer (e.g., a microphone), by ways of example, and can be interconnected to the computer 102 via an input interface 1518. The output device 1506 can comprise a display, a printer, a transducer (e.g., a speaker), by ways of examples, and be interconnected to the computer 102 via an output interface 1520. Some devices, such as a network adapter or a modem, can be used as input and/or output devices.

As can be familiar to those skilled in the art, the computer system 1500 further includes an operating system and at least one application program. The operating system can be the set of software which controls the computer system's operation and the allocation of resources. The application program can be the set of software that performs a task desired by the user, using computer resources made available through the operating system. Both are resident in the illustrated memory system 106.

In accordance with the practices of persons skilled in the art of computer programming, the present disclosure can be described below with reference to symbolic representations of operations that are performed by the computer system 1500. Such operations are sometimes referred to as being computer-executed. It can be appreciated that the operations which are symbolically represented include the manipulation by the CPU 104 of electrical signals representing data bits and the maintenance of data bits at memory locations in the memory system 106, as well as other processing of signals. The memory locations where data bits are maintained are physical locations that have particular electrical, magnetic, or optical properties corresponding to the data bits. The various embodiments as described in this disclosure can be implemented in a program or programs, comprising a series of instructions stored on a computer-readable medium. The computer-readable medium can be any of the devices, or a combination of the devices, described above in connection with the memory system 106.

The AC&A System 100 as described herein can reduce the cost associated with completing C&A actions by reducing the labor hours and travel time needed to complete a C&A. The AC&A System 100 can complete these C&A actions automatically and has been shown, in some embodiments, to reduce the required labor by 50 percent, while also reducing the number and occurrence of human errors occurring during the processes. There is a huge backlog of target computer assets or systems that require C&A actions and the AC&A System 100 and methods as described by this disclosure will allow organizations the flexibility and automation they need to complete these actions in a timely and efficient and accurate manner.

### Exemplary Operations and Applications

The exemplary AC&A System 100 as described herein provides the ability to simplify/automate key principles of security testing, evaluation, and documentation including compliance report generation. The documentation that can be generated can comply with standards as dictated by the government such that the documentation is in compliance with the corresponding standards. Also, the system and method provides for collation of all pertinent test results into a readily available database and can provide a historical reference for long term analysis and tracking. However, it is possible that these methods and systems can apply to more than just security principles, as an AC&A System is simply an interface into these datasets from specific vectors in the Vector database can provide multiple outputs as dictated by customer requirements.

For Example, OSHA has multiple mandates for compliance with standards and regulation. The test cases that are determined from the requirements could easily be changed from a security specific slant into a workplace environment slant with no functional change to the underlying database structure. e.g., the test case for determining whether a minimum height to threshold elevation was met (passed/failed) could be recorded into the database, along with numerous other findings. These findings can then be used to generate an official report in the OSHA mandated format, thereby saving the man hours that would be spent in the tedious minutiae of detailed report generation.

The following is a flow/hierarchy of items of one exemplary embodiment of an AC&A System and method. In this example, the IA Control is a Security requirement such as defined by the Department of Defense Instructions/Directives that state in a Source Document the predefined requirement for a computer security feature or characteristic. As such in this example, the AC&A System implements IA validation as defined by the Source Document, the DIACAP process.

For example, this can be one or more STIG (implementation specific requirements for a particular type of computer operating system as are known in the art. As known to those skilled in the art, these STIGs are released randomly and on an as needed basis. One or more checks as defined in by the documents become Test Cases as described herein and the checklists as defined in the documents become Test Plans. The IA Control is derived from the requirements in the Source Document and there is a Test Reference between the Test Case and the Source Document. Each Test Case contains individually testable configuration details as defined by the predefined requirement. Additionally, the Test Case contains all previous items/levels for coordination, for example, in this case it may contain 8500.2 ESCD-1, windows STIG P2P dependency, that FIPS 140 must be used for all connections, all relevant known information about a specific check and any research notes or comments from testers that is not included in any of the supplied documentation.

While a single instance is shown in these examples, it should be understood by those skilled in the art that there are typically a one-to-many relationship between each component, and entity and related data component.

After a test case or a test plan having one or more test cases is performed on a System (target asset), the test event provided the Results of such tests which include a validation of other Predetermined requirements. Additionally, the Results can include historical data for comparison purposes.

In one specific exemplary embodiment, as described above, Test Cases are Compliance requirements and IA Controls and Source Documents are two examples of Predetermined requirements. In this exemplary embodiment the method includes receiving a predetermined requirement for compliance testing of a target asset. As noted the predetermined requirement can be of any form of requirement and can include, in some exemplary embodiments as described herein, an information assurance (IA) control or a source document. For example, a new publication such as a standard may be released that states that all users of an asset system must have their password be a minimum length of 16 characters. The password length of 16 characters can be a new predetermined requirement. A new test case is created to provide for testing for compliance of this new predetermined requirement. The new test case for this predetermined requirement is received by the AC&A System and is stored in its memory such as in a database.

The user can select the command “Administration” from the main navigation menu. The user then selects “IA Controls” from the navigation sub-menu. In the sub-menu, the user selects the command “Add IA Control” and can be prompted to enter the pertinent information about the control.

The user can select “Administration” from the main navigation menu. The user then selects “Source Documents” from the navigation sub-menu. In the sub-menu, the user can select the command “Add Source Document” and can be prompted to enter the name, version, and date for the document.

According to this exemplary embodiment the method also includes comparing the received predetermined requirement to stored compliance requirement sets to identify whether one or more of the stored compliance requirement sets corresponds to the received predetermined requirement. For example, a new publication may be released that states that all users must have their password be a minimum length of 16 characters (a predetermined requirement).

The user can select the command “Test Cases” from the main navigation menu. The user can then enters the word “password” into the filter and select the command “Search”. The page then refreshes to show all corresponding test cases.

Upon finding the appropriate test case, the user can select the selected test case and the data about the specific test case is displayed. The user can then navigate the sub-menus by selecting “Test Plans” to see the corresponding test plans that the specific test case is listed in.

In another process of the method, wherein the comparing identifies one or more corresponding requirement sets, modifying at least one of the corresponding compliance requirement sets responsive to the received predetermined requirement to generate a modified compliance requirement set.

For example, a new publication may be released that states that all users must have their password be a minimum length of 16 characters (a predetermined requirement). This requirement must be entered (received) into the database.

Having selected the appropriate test case, the user can navigate the sub-menu by selecting “Test Plans”. The user can then select the command “Add”, and can then be prompted to select a test plan from a drop-down box.

In another process of the method, wherein the comparing fails to identify at least one corresponding requirement set, generating a new compliance requirement set responsive to the received predetermined requirement.

For example, a new publication is released which states that all systems must be painted a certain color to identify their classification level. Having validated that the new requirement does not exist at all and does not fit into any of the existing requirement sets, the user can navigate the main menu and select “Test Plan Manager”. The user selects the command “Add Test Plan” and can then be prompted to enter the name of the test plan.

In yet another exemplary operation, the method includes comparing the received predetermined requirement to stored compliance requirements to identify whether one or more stored compliance requirements corresponds to the received predetermined requirement. For example, where a new publication is released that requires all system users to have a password with a minimum length of 16 characters (a predetermined requirement). This requirement (test case) must be entered (received) into the database.

The method starts with a comparing or searching for an applicable Test Case. The user selects Test Cases from a navigation menu. The user then enters the word “password” into the filter and selects a Search. The page then refreshes to show all corresponding test cases. Where at least one stored compliance requirement corresponds to the received predetermined requirement of a password, it is possible to modify at least one corresponding compliance requirement responsive to the received predetermined requirement to generate a modified corresponding compliance requirement for this new requirement.

For example, where another new publication is released that now requires all users to have a password a minimum length of 32 characters (a new predetermined requirement); this is a new requirement that must be entered into a new test case for testing. In this case after finding an associated existing test case, the user selects a corresponding test case and reviews all of the specific parameters thereof. This can include the requirement description, the IA control 212, and the test reference 326, and the source documents 324. The user can modify this information as necessary, and when finished then commits this to the AC&A System 100 saving it as a new Test Case. If there is no corresponding IA control 2121 or source document 324, then the user enters that information and edits the test case 222 accordingly.

Where no stored compliance requirement corresponds to the received predetermined requirement, a new compliance requirement has to be generated to account for the new predetermined requirement. For example, wherein the new publication that is released is the one with the 6 character password, as this is a new predetermined requirement, this requirement must be entered as a new test case.

The user selects “Test Cases” and adds the new Test Case via the GUI. The user must enter the name, category, and test plan to which the new test case belongs. Once this information is entered, the user can be prompted to enter the specifics for the test case, which includes the specific requirement description, the IA control 212, and the test reference 326 that identifies the source document 324. The user then stores this in the memory of the AC&A System 100. If there is no corresponding IA control 212 or source document 324, then the user also enters that information and edits the test case 222 accordingly.

In another process, the method includes receiving a selected target asset from among a plurality of assets. For example, a new workstation is built for a new employee. This new machine must be checked for compliance. In this case, a new profile may be required for this new target asset. Additionally, a new test event may be required. In the later case, the user selects “Administration” from the main navigation menu. The user then selects “Systems” from the navigation sub-menu. The user then selects the system for which he wishes to create the test event. If the system the user desires is not listed, he can add the new system. The user can select a command such as “Add” for adding a new “test event.” The user can be prompted to enter the name, start date, end date, and whether the test event is considered a baseline.

In another embodiment, the system and method provides for validating the profile of the selected target asset against at least one of the new or modified corresponding compliance requirement sets. Where the new workstation was built for a new employee, the user can select “Test Event Manager” from the main navigation menu. The user can select the desired test event from the drop-down box. The user then navigates the sub-menu and selects “Results.” The user selected a command such as “Add Test Case” and a search window can be presented to the user to search through all test cases to find the desired test case. The user can then select the desired test case.

In some cases, a Test Plan may be added to a test event. In these cases the user selects “Test Event Manager” from the main navigation menu. The user then selects the desired test event from the drop-down box. The user then navigates the sub-menu and selects “Results”. The user selects a command “Add Test Plan” and can be prompted to select the appropriate test plan from a drop-down box.

In yet another embodiment, the method includes transmitting the generated corresponding compliance requirement set to an external system or an output device. For example, this can include, as described, the new workstation for a new employee. The process continues with the exporting a Test Plan. The user selects “Test Plan Manager” from the main navigation menu. The user selects the desired test plan from the list of test plans. The system then shows all of the information associated with the selected test plan. The user selects a command such as “Export” and can be prompted with a dialog to save a PDF formatted file of the test plan to his local computer.

The results data is received from the external system or an input device responsive to the transmitting, the received results data including a correlation to one or more compliance requirements within the transmitted compliance requirement set. This can also include importing results data. The user selects “Test Event Manager” from the main navigation menu. The user then selects the desired test event from the drop-down box. The user then navigates the sub-menu and selects “test event Info”. The user selects the command “Browse . . . ” and can be prompted to select a file from his local computer to upload to the web server. Once the user has selected the file, the user then selects a command such as “Import Findings” to upload the appropriate file to the web server.

Additionally the user must select the associated machine. The user selects “Test Event Manager” from the main navigation menu. The user then selects the desired test event from the drop-down box. The user then navigates the sub-menu and selects “Results”. The user selects the appropriate test case and navigates the sub-menu and selects the “Findings”. The user then selects a command such as “Add Finding” and can be prompted to enter a machine name, whether the results are system wide, if the finding is a failure, and the actual results.

The method continues with the process of validating the received results data to determine compliance with at least one of the new or modified corresponding compliance requirement sets. The user selects “Test Event Manager” from the main navigation menu. The user then selects the desired test event from the drop-down box. The user then navigates the sub-menu and selects “Results”. The user selects the appropriate test case and navigates the sub-menu and selects the “Findings”. The user can select a test case link and a window can be displayed showing all of the pertinent compliance information, which includes the specific requirement description, the IA control, the reference documents (source documents), and all other information that is applicable. The user can then compare this compliance information with the information in the field “Actual Result” of the specific machine. Based upon this validation, the user then can edit the specific finding, if necessary.

The finding for a machine may also be edited. Where this is desired, the user can select “Test Event Manager” from the main navigation menu. The user then selects the desired test event from the drop-down box. The user then navigates the sub-menu and selects “Results”. The user selects the appropriate test case and navigates the sub-menu and selects the “Findings”. The user then selects the appropriate machine he wishes to edit, and can perform an editing of this. The user can then be prompted to change the machine name, whether the results are system wide, if the finding is a failure, and the actual results.

A compliance report that is responsive to the validating can also be published. In such cases, as described above, the user can select “Test Event Manager” from the main navigation menu. The user then selects the desired test event from the drop-down box. The user then navigates the sub-menu and selects “Findings Report”. The user selects a command such as “Generate Findings Report” and can then be prompted with a dialog to save a standards spreadsheet formatted file of the findings. Such a report can comply with various reporting requirements including, for example, the DODI-8510.01 instructions.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described. Those skilled in the art will further recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A computer readable medium having instructions for causing a computer to execute a method for automated management of compliance of a target asset to a predetermined requirement, the method comprising:
receiving a predetermined requirement for compliance testing of one of a plurality of assets;
comparing the received predetermined requirement to one or more stored compliance requirements to identify whether one or more stored compliance requirements corresponds to the received predetermined requirement;
where one or more of the stored compliance requirement corresponds to the received predetermined requirement, modifying at least one corresponding compliance requirement responsive to the received predetermined requirement to generate a new compliance requirement; and
where the received requirement does not correspond to at least one stored compliance requirements, generating a new compliance requirement responsive to the received predetermined requirement;
selecting a target asset from among the plurality of assets;
transmitting the new compliance requirement;
receiving results responsive to the transmitted new compliance requirement;
validating the received results to determine compliance of the target asset with the predetermined requirement as identified in the received results; and
publishing a compliance report including the received results responsive to the validating.

2. The computer readable medium of claim 1 wherein receiving the predetermined requirement includes receiving a source document including the predetermined requirement;

3. The computer readable medium of claim 1 wherein each such asset has a profile including a category and classification for the asset; the instructions further perform the method comprising:
identifying a new asset;
creating a new profile for the new asset including a classification and a category associated with the new asset;
identifying one or more stored compliance requirements associated with the classification and category within the created profile of the new asset; and
automatically adding the identified one or more stored compliance requirements to the new profile for the new asset.

4. The computer readable medium of claim 1 wherein the target asset is a system having a plurality of machines and the compliance requirement is a system level compliance requirement, and wherein transmitting the new compliance requirement includes transmitting associated with each of the machines of the target asset and receiving results is for each of the machines.

5. The computer readable medium of claim 4 wherein receiving results includes receiving an XML data file containing the results.

6. The computer readable medium of claim 1 wherein the method further comprising identifying any failures from the received results, creating a program management responsive to the failures, the program management including mitigation responses to the failures, and wherein publishing further includes publishing a program management report.

7. A computer readable medium having instructions for causing a computer to execute a method for automated management of compliance of a target asset to a predetermined requirement, the method comprising:
receiving a predetermined requirement for compliance testing of the target asset;
comparing the received predetermined requirement to one or more stored compliance requirement sets to identify whether one or more of the stored compliance requirement sets corresponds to the received predetermined requirement;
where the comparing identifies one or more stored compliance requirement sets that correspond to the received predetermined requirement, modifying at least one of the corresponding compliance requirement sets responsive to the received predetermined requirement to generate a new compliance requirement set;
where the comparing fails to identify at least one stored compliance requirement set, generating a new compliance requirement set responsive to the received predetermined requirement;
comparing the received predetermined requirement to one or more stored compliance requirements to identify whether one or more stored compliance requirements corresponds to the received predetermined requirement;
where one or more of the stored compliance requirement corresponds to the received predetermined requirement, modifying at least one corresponding compliance requirement responsive to the received predetermined requirement to generate a new compliance requirement; and
where the received requirement does not correspond to at least one stored compliance requirements, generating a new compliance requirement responsive to the received predetermined requirement.

8. The computer readable medium of claim 7 wherein the asset is a computer system and wherein the predetermined requirement is a computer system security requirement for which the computer system is required to comply.

9. The computer readable medium of claim 7 wherein comparing the received predetermined requirement to a stored compliance requirement includes:
reviewing the received predetermined requirement;
identifying deficiencies in at least one of the stored compliance requirements;
reviewing support documentation responsive to the identified deficiencies;
preparing solutions to address the identified deficiencies in support of the predetermined requirement; wherein modifying at least one corresponding compliance requirement includes the prepared solutions.

10. The computer readable medium method of claim 7 wherein the computer executable instruction include the method of performing a quality assurance check of the new compliance requirement set responsive to the compliance requirements.

11. The computer readable medium method of claim 7 wherein the computer executable instruction include the method of flagging the new compliance requirement set as being updated following successfully performing the quality assurance check.

12. The computer readable medium method of claim 7 wherein the computer executable instruction include the method of:
creating a profile for a different target asset for the target asset among the plurality of assets; and
storing the created target asset profile.

13. The computer readable medium method of claim 7 wherein at least one of the stored compliance requirement sets includes a plurality of compliance requirements and wherein selecting all or a portion of a stored compliance requirement set includes selecting a subset of the plurality of the compliance requirements.

14. The computer readable medium method of claim 7 wherein generating the compliance requirement set includes generating test questions adapted to evaluate and/or quantify one or more steps of the generated compliance requirement set.

15. The computer readable medium method of claim 7 wherein the computer executable instruction include the method of:
generating one or more instructions for initiating at least one remote test case included in the new compliance requirement set;
logging results associated with the generated instruction remote test case;
importing the results data following logging; and
assigning the received results to at least one of the compliance requirement set, the profile, and at least one of the remote test cases.

16. The computer readable medium method of claim 7 wherein the asset is a computer system and wherein the received predetermined requirement is selected from the group consisting of Department of Defense Instructions/Directives for computer security such as DODI 8510, DODI 8500.2, DODD 8500.1, and DISA Security Technical Implementation Guides and security checklists

17. The computer readable medium method of claim 7 wherein the predetermined requirements include parameters selected from the group consisting of policies, procedures, guidelines, laws, and regulations.

18. The computer readable medium method of claim 7 wherein the computer executable instruction include the method of:
receiving a selection of the target asset from among a plurality of assets;
establishing a profile for the selected target asset;
validating the profile of the selected target asset against at least one of the new or modified corresponding compliance requirement sets;
transmitting the generated corresponding compliance requirement set to an external system or an output device;
receiving results data from the external system or an input device responsive to the transmitting, the received results data including a correlation to one or more compliance requirements within the transmitted compliance requirement set;
validating the received results data to determine compliance with at least one of the new or modified corresponding compliance requirement set; and
publishing a compliance report responsive to the validating.

19. The computer readable medium method of claim 18 wherein the predetermined requirements are the first predetermined requirements, wherein the method further comprises importing second predetermined requirements, wherein the second predetermined requirements replaces in whole or in part the first predetermined requirements.

20. The computer readable medium method of claim 18 wherein publishing the compliance report includes formatting all or a portion of the results data and the predetermined requirements into a format defined by the predetermined requirements.

21. A computer readable medium having instructions for causing a computer to execute a method for automated management of compliance of a target asset to a predetermined requirement, the method comprising:
receiving a selection of the target asset from among a plurality of assets; establishing a profile for the selected target asset;
validating the profile of the selected target asset against at least one compliance requirement sets;
transmitting the generated corresponding compliance requirement set to an external system or an output device;
receiving results data from the external system or an input device responsive to the transmitting, the received results data including a correlation to one or more compliance requirements within the transmitted compliance requirement set;
validating the received results data to determine compliance with at least one of the new or modified corresponding compliance requirement set; and
publishing a compliance report responsive to the validating.

22. The computer readable medium method of claim 21 wherein the asset is a computer system, wherein the predetermined requirement is a computer system security requirement for which the computer system is required to comply.

23. The computer readable medium method of claim 21 wherein publishing the compliance report includes formatting all or a portion of the results data and the predetermined requirements into a format defined by the predetermined requirements.

24. The computer readable medium method of claim 21 wherein the predetermined requirement includes parameters selected from the group consisting of policies, procedures, guidelines, laws, and regulations.

25. The computer readable medium method of claim 21 wherein the predetermined requirements are the first predetermined requirements, wherein the method further comprises importing second predetermined requirements, wherein the second predetermined requirements replaces in whole or in part the first predetermined requirements.
